(19) United States
(12) Patent Application Publication
(10) Pub. No.: US 2020/0255739 A1
(43) Pub. Date: Aug. 13, 2020

(54) LIGHT MODULATION ELEMENT

(71) Applicant: Merck Patent GmbH, Darmstadt (DE)

(72) Inventors: Bernd FIEBRANZ, Muenster (DE); Peter BEST, Babenhausen (DE); Meike KRUMWIEDE, Darmstadt (DE); Simon SIEMIANOWSKI, Darmstadt (DE)

(73) Assignee: Merck Patent GmbH, Darmstadt (DE)

(21) Appl. No.: 16/302,391

(22) PCT Filed: May 16, 2017
(86) PCT No.: PCT/EP2017/061654

§ 371 Date: Nov. 16, 2018

(30) Foreign Application Priority Data
May 17, 2016 (EP) 16169933.5

(51) Int. Cl. C09K 19/36; C09K 19/56; C09K 19/58; G02F 1/1343; G02F 1/1337; G02F 1/1335; G02F 1/1341

(52) U.S. Cl. CPC C09K 19/36; C09K 19/56; C09K 19/586; G02F 1/134309; G02F 2001/133354; G02F 1/133784; G02F 1/133528; G02F 1/1341; G02F 2001/133738; G02F 1/133753

(57) ABSTRACT

A light modulation element comprising, preferably consisting of a cholesteric liquid crystalline medium sandwiched between two opposing substrates, an electrode arrangement, which is capable to allow the application of an electric field, which is substantially perpendicular to the main plane of substrate or the layer of the cholesteric liquid-crystalline medium, characterized in that one of the substrates is provided with a processed alignment layer adjacent to the cholesteric liquid crystalline medium and the other substrate is either provided with an unprocessed alignment layer adjacent to the cholesteric liquid crystalline medium or is not provided with an alignment layer. The invention is further related to a method of production of said light modulation element and to the use of said light modulation element in various types of optical and electro-optical devices, such as electro-optical displays, liquid crystal displays (LCDs), non-linear optic (NLO) devices, and optical information storage devices.

The invention relates to a light modulation element comprising, preferably consisting of a cholesteric liquid crystalline medium sandwiched between two opposing substrates, an electrode arrangement, which is capable to provide an electric field substantially perpendicular to the main plane of substrate or the layer of the cholesteric liquid-crystalline medium, characterized in that one of the substrates is provided with a processed alignment layer adjacent to the cholesteric liquid crystalline medium and the other substrate is either provided with an unprocessed alignment layer adjacent to the cholesteric liquid crystalline medium or is not provided with an alignment layer. The invention is further related to a method of production of said light modulation element and to the use of said light modulation element in various types of optical and electro-optical devices, such as electro-optical displays, liquid crystal displays (LCDs), non-linear optic (NLO) devices, and optical information storage devices.

Liquid Crystal Displays (LCDs) are widely used to display information. LCDs are used for direct view displays, as well as for projection type displays. The electro-optical mode, which is employed for most displays, still is the twisted nematic (TN)-mode with its various modifications. Besides this mode, the super twisted nematic (STN)-mode and more recently the optically compensated bend (OCB)-mode and the electrically controlled birefringence (ECB)-mode with their various modifications, as e. g. the vertically aligned nematic (VAN), the patterned ITO vertically aligned nematic (PVA)-, the polymer stabilized vertically aligned nematic (PSVA)-mode and the multi domain vertically aligned nematic (MVA)-mode, as well as others, have been increasingly used. All these modes use an electrical field, which is substantially perpendicular to the substrates, respectively to the liquid crystal layer. Besides these modes there are also electro-optical modes employing an electrical field substantially parallel to the substrates, respectively the liquid crystal layer, like e.g. the In Plane Switching (short IPS) mode (as disclosed e.g. in DE 40 00 451 and EP 0 588 568) and the Fringe Field Switching (FFS) mode. Especially the latter mentioned electro-optical modes, which have good viewing angle properties and improved response times, are increasingly used for LCDs for modern desktop monitors and even for displays for TV and for multimedia applications and thus are competing with the TN-LCDs.

Further to these displays, new display modes using cholesteric liquid crystals having a relatively short cholesteric pitch have been proposed for use in displays exploiting the so-called “flexoelectric” effect, which is described inter alia by Meyer et al., Liquid Crystals 1987, 58, 15; Chandrasekhar, “Liquid Crystals”, 2nd edition, Cambridge University Press (1992); and P. G. deGennes et al., “The Physics of Liquid Crystals”, 2nd edition, Oxford Science Publications (1995).

Displays exploiting flexoelectric effect are generally characterized by fast response times typically ranging from 500 μs to 3 ms and further feature excellent grey scale capabilities.

In these displays, the cholesteric liquid crystals are e.g. oriented in the “uniformly lying helix” arrangement (ULH), which also give this display mode its name. For this purpose, a chiral substance, which is mixed with a nematic material, induces a helical twist whilst transforming the material into a chiral nematic material, which is equivalent to a cholesteric material.

The uniform lying helix texture is realized using a chiral nematic liquid crystal with a short pitch, typically in the range from 0.2 μm to 2 μm, preferably of 1.5 μm or less, in particular of 1.0 μm or less, which is unidirectional aligned with its helical axis parallel to the substrates of a liquid crystal cell. In this configuration, the helical axis of the chiral nematic liquid crystal is equivalent to the optical axis of a birefringent plate.

If an electrical field is applied to this configuration normal to the helical axis, the optical axis is rotated in the plane of the cell, similar as the director of a ferroelectric liquid crystal rotate as in a surface stabilized ferroelectric liquid crystal display.

In liquid crystal displays exploiting the flexoelectric modes the tilt angle (O) describes the rotation of the optic axis in the x-y plane of the cell. There are two basic methods of using this effect to generate a white and dark state. The biggest difference between these two methods resides in the tilt angle that is required and in the orientation of the transmission axis of the polarizer relative the optic axis for the ULH in the zero field state.

The main difference between the “Θ mode” and the “2Θ mode” is that the optical axis of the liquid crystal in the state at zero field is either parallel to one of the polarizer axis (in the case of the 2Θ mode) or at an angle of 22.5° to axis one of the polarizers (in the case of the Θ mode). The advantage of the 2Θ mode over the Θ mode is that the liquid crystal display appears black when there is no field applied to the cell. The advantage of the Θ mode, however, is that e/K may be lower because only half of the switching angle is required for this mode compared to the 2Θ mode.

The angle of rotation of the optical axis (Φ) is given in good approximation by the following equation

tan Φ=ēP₀E/(2πK)

wherein
P₀ is the undisturbed pitch of the cholesteric liquid crystal,
ē is the average [ē=½(e_{splay}+e_{bend})] of the splay flexoelectric coefficient (e_{splay}) and the bend flexoelectric coefficient (e_{bend}),
E is the electrical field strength and
K is the average [K=½(k₁₁+k₃₃)] of the splay elastic constant (k₁₁) and the bend elastic constant (K₃₃)

and wherein
ē/K is called the flexo-elastic ratio.

This angle of rotation is half the switching angle in a flexoelectric switching element.

The response time (t) of this electro-optical effect is given in good approximation by the following equation

τ=[P₀/(2π)]²·γ/K

wherein
γ is the effective viscosity coefficient associated with the distortion of the helix.

There is a critical field (E_{c}) to unwind the helix, which can be obtained from the following equation

E_{c}=(π²/P₀)·[k₂₂/(ε₀·Δε)]^{1/2} (3)

wherein

k₂₂ is the twist elastic constant,

ε₀ is the permittivity of vacuum and

Δε is the dielectric anisotropy of the liquid crystal.

However, the main obstacle preventing the mass production of a ULH display is that its alignment is intrinsically unstable and up to now, no single surface treatment (planar, homeotropic or tilted) provides an energetically stable state with additional directionality of the ULH texture. Due to this, obtaining a high quality dark state is difficult as large amounts of defects are present when conventional cells are used.

Attempts to improve ULH alignment mostly involving polymer structures on surfaces or bulk polymer networks, such as, for example described in,
Appl. Phys. Lett. 2010, 96, 113503 “Periodic anchoring condition for alignment of a short pitch cholesteric liquid crystal in uniform lying helix texture”;
Appl. Phys. Lett. 2009, 95, 011102, “Short pitch cholesteric electro-optical device based on periodic polymer structures”;
J. Appl. Phys.2006, 99, 023511, “Effect of polymer concentration on stabilized large-tilt-angle flexoelectro-optic switching”;
J. Appl. Phys. 1999, 86, 7, “Alignment of cholesteric liquid crystals using periodic anchoring”;
Jap. J. Appl. Phys. 2009, 48, 101302, “Alignment of the Uniform Lying Helix Structure in Cholesteric Liquid Crystals” or US 2005/0162585 A1.

Another attempt to improve ULH alignment was suggested by Carbone et al. in Mol. Cryst. Liq. Cryst. 2011, 544, 37-49. The authors utilized a surface relief structure created by curing an UV curable material by a two-photon excitation laser-lithography process in order to promote the formation of a stable ULH texture.

However, all above-described attempts require unfavorable processing steps, which are especially not compatible with the commonly known methods for mass production of LC devices.

Thus, one aim of the invention is to provide an alternative or preferably improved flexoelectric light modulation element of the ULH mode, which does not have the drawbacks of the prior art and preferably have the advantages mentioned above and below.

These advantages are amongst others, favourable high switching angles, favorable fast response times, favorable low voltage required for addressing, compatibility with common driving electronics, and finally, a favorable really dark “off state”, which should be achieved by an long term stable alignment of the ULH texture.

Other aims of the present invention are immediately evident to the person skilled in the art from the following detailed description.

Surprisingly, the inventors have found out that one or more of the above-defined aims can be achieved by providing a light modulation element as comprising, preferably consisting of a cholesteric liquid crystalline medium sandwiched between two opposing substrates, an electrode arrangement, which is capable to allow the application of an electric field, which is substantially perpendicular to the substrate main plane or the cholesteric liquid-crystalline medium layer, characterized in that one of the substrates is provided with a processed alignment layer adjacent to the cholesteric liquid crystalline medium and the other substrate is optionally provided with an unprocessed alignment layer adjacent to the cholesteric liquid crystalline medium.

In particular, the stability of the ULH texture of the cholesteric liquid crystal material in the light modulation element of the present invention is significantly improved and finally results in an improved dark “off” state compared to devices of the prior art.

### Terms and Definitions

The term “liquid crystal”, “mesomorphic compound”, or “mesogenic compound” (also shortly referred to as “mesogen”) means a compound that under suitable conditions of temperature, pressure and concentration can exist as a mesophase (nematic, smectic, etc.) or in particular as a LC phase. Non-amphiphilic mesogenic compounds comprise for example one or more calamitic, banana-shaped or discotic mesogenic groups.

The term “mesogenic group” means in this context, a group with the ability to induce liquid crystal (LC) phase behaviour. The compounds comprising mesogenic groups do not necessarily have to exhibit an LC phase themselves. It is also possible that they show LC phase behaviour only in mixtures with other compounds. For the sake of simplicity, the term “liquid crystal” is used hereinafter for both mesogenic and LC materials.

Throughout the application, unless stated explicitly otherwise, the term “aryl and heteroaryl groups” encompass groups, which can be monocyclic or polycyclic, i.e. they can have one ring (such as, for example, phenyl) or two or more rings, which may also be fused (such as, for example, naphthyl) or covalently linked (such as, for example, biphenyl), or contain a combination of fused and linked rings.

Heteroaryl groups contain one or more heteroatoms, preferably selected from O, N, S and Se. Particular preference is given to mono-, bi- or tricyclic aryl groups having 6 to 25 C atoms and mono-, bi- or tricyclic heteroaryl groups having 2 to 25 C atoms, which optionally contain fused rings, and which are optionally substituted. Preference is furthermore given to 5-, 6- or 7-membered aryl and heteroaryl groups, in which, in addition, one or more CH groups may be replaced by N, S or O in such a way that O atoms and/or S atoms are not linked directly to one another. Preferred aryl groups are, for example, phenyl, biphenyl, terphenyl, [1,1′:3′,1″]terphenyl-2′-yl, naphthyl, anthracene, binaphthyl, phenanthrene, pyrene, dihydropyrene, chrysene, perylene, tetracene, pentacene, benzopyrene, fluorene, indene, indenofluorene, spirobifluorene, more preferably 1,4-phenylene, 4,4′-biphenylene, 1, 4-tephenylene.

Preferred heteroaryl groups are, for example, 5-membered rings, such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6-membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, isoindole, indolizine, indazole, benzimidazole, benzotriazole, purine, naphthimidazole, phenanthrimidazole, pyridimidazole, pyrazinimidazole, quinoxalinimidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]thiophene, dithienothiophene, isobenzothiophene, dibenzothiophene, benzothiadiazothiophene, or combinations of these groups. The heteroaryl groups may also be substituted by alkyl, alkoxy, thioalkyl, fluorine, fluoroalkyl or further aryl or heteroaryl groups.

In the context of this application, the term “(non-aromatic) alicyclic and heterocyclic groups” encompass both saturated rings, i.e. those that contain exclusively single bonds, and partially unsaturated rings, i.e. those that may also contain multiple bonds. Heterocyclic rings contain one or more heteroatoms, preferably selected from Si, O, N, S and Se. The (non-aromatic) alicyclic and heterocyclic groups can be monocyclic, i.e. contain only one ring (such as, for example, cyclohexane), or polycyclic, i.e. contain a plurality of rings (such as, for example, decahydronaphthalene or bicyclooctane). Particular preference is given to saturated groups. Preference is furthermore given to mono-, bi- or tricyclic groups having 3 to 25 C atoms, which optionally contain fused rings and that are optionally substituted. Preference is furthermore given to 5-, 6-, 7- or 8-membered carbocyclic groups in which, in addition, one or more C atoms may be replaced by Si and/or one or more CH groups may be replaced by N and/or one or more non-adjacent CH₂ groups may be replaced by —O— and/or —S—.

Preferred alicyclic and heterocyclic groups are, for example, 5-membered groups, such as cyclopentane, tetrahydrofuran, tetrahydrothiofuran, pyr-rolidine, 6-membered groups, such as cyclohexane, silinane, cyclohexene, tetrahydropyran, tetrahydrothiopyran, 1,3-dioxane, 1,3-dithiane, piperidine, 7-membered groups, such as cycloheptane, and fused groups, such as tetrahydronaphthalene, decahydronaphthalene, indane, bicyclo[1.1.1]-pentane-1,3-diyl, bicyclo[2.2.2]octane-1,4-diyl, spiro[3.3]heptane-2,6-diyl, octahydro-4,7-methanoindane-2,5-diyl, more preferably 1,4-cyclohexylene 4,4′-bicyclohexylene, 3,17-hexadecahydro-cyclopenta[a]phenanthrene, optionally being substituted by one or more identical or different groups L.

Especially preferred aryl-, heteroaryl-, alicyclic- and heterocyclic groups are 1,4-phenylene, 4,4′-biphenylene, 1, 4-terphenylene, 1,4-cyclohexylene, 4,4′-bicyclohexylene, and 3,17-hexadecahydro-cyclopenta[a]-phenanthrene, optionally being substituted by one or more identical or different groups L.

Preferred substituents of the above-mentioned aryl-, heteroaryl-, alicyclic- and heterocyclic groups (L) are, for example, solubility-promoting groups, such as alkyl or alkoxy and electron-withdrawing groups, such as fluorine, nitro or nitrile.

Particularly preferred substituents are, for example, halogen, CN, NO₂, CH₃, C₂H₅, OCH₃, OC₂H₅, COCH₃, COC₂H₅, COOCH₃, COOC₂H₅, CF₃, OCF₃, OCHF₂ or OC₂F₅.

Above and below “halogen” denotes F, Cl, Br or I.

Above and below, the terms “alkyl”, “aryl”, “heteroaryl”, etc., also encompass polyvalent groups, for example alkylene, arylene, heteroarylene, etc.

The term “aryl” denotes an aromatic carbon group or a group derived there from.

The term “heteroaryl” denotes “aryl” in accordance with the above definition containing one or more heteroatoms.

Preferred alkyl groups are, for example, methyl, ethyl, n-propyl, isopropyl, n-butyl, isobutyl, s-butyl, t-butyl, 2-methylbutyl, n-pentyl, s-pentyl, cyclo-pentyl, n-hexyl, cyclohexyl, 2-ethylhexyl, n-heptyl, cycloheptyl, n-octyl, cyclooctyl, n-nonyl, n-decyl, n-undecyl, n-dodecyl, dodecanyl, trifluoro-methyl, perfluoro-n-butyl, 2,2,2-trifluoroethyl, perfluorooctyl, perfluorohexyl, etc.

Preferred alkoxy groups are, for example, methoxy, ethoxy, 2-methoxy-ethoxy, n-propoxy, i-propoxy, n-butoxy, i-butoxy, s-butoxy, t-butoxy, 2-methylbutoxy, n-pentoxy, n-hexoxy, n-heptoxy, n-octoxy, n-nonoxy, n-decoxy, n-undecoxy, n-dodecoxy.

Preferred alkenyl groups are, for example, ethenyl, propenyl, butenyl, pentenyl, cyclopentenyl, hexenyl, cyclohexenyl, heptenyl, cycloheptenyl, octenyl, cyclooctenyl.

Preferred alkynyl groups are, for example, ethynyl, propynyl, butynyl, pen-tynyl, hexynyl, octynyl.

Preferred amino groups are, for example, dimethylamino, methylamino, methylphenylamino, phenylamino.

The term “chiral” in general is used to describe an object that is non-superimposable on its mirror image.

“Achiral” (non-chiral) objects are objects that are identical to their mirror image.

The terms “chiral nematic” and “cholesteric” are used synonymously in this application, unless explicitly stated otherwise.

The pitch induced by the chiral substance (P₀) is in a first approximation inversely proportional to the concentration (c) of the chiral material used.

The constant of proportionality of this relation is called the helical twisting power (HTP) of the chiral substance and defined by the following equation

HTP≡1/(c·P₀) (5)

wherein

c is concentration of the chiral compound.

The term “bimesogenic compound” relates to compounds comprising two mesogenic groups in the molecule. Just like normal mesogens, they can form many mesophases, depending on their structure. In particular, bimesogenic compound may induce a second nematic phase, when added to a nematic liquid crystal medium. Bimesogenic compounds are also known as “dimeric liquid crystals”.

“Ultraviolet (UV) light” is electromagnetic radiation having a wavelength in the range between approximately 400 nm and 200 nm.

The term “director” is known in prior art and means the preferred orientation direction of the long molecular axes (in case of calamitic compounds) or short molecular axes (in case of discotic compounds) of the liquid-crystalline molecules. In case of uniaxial ordering of such anisotropic molecules, the director is the axis of anisotropy.

The term “alignment” or “orientation” relates to alignment (orientation ordering) of anisotropic units of material such as small molecules or fragments of big molecules in a common direction named “alignment direction”. In an aligned layer of liquid-crystalline material, the liquid-crystalline director coincides with the alignment direction so that the alignment direction corresponds to the direction of the anisotropy axis of the material.

The term “planar orientation/alignment”, for example in a layer of an liquid-crystalline material, means that the long molecular axes (in case of calamitic compounds) or the short molecular axes (in case of discotic compounds) of a proportion of the liquid-crystalline molecules are oriented substantially parallel (about 180°) to the plane of the layer.

The term “homeotropic orientation/alignment”, for example in a layer of a liquid-crystalline material, means that the long molecular axes (in case of calamitic compounds) or the short molecular axes (in case of discotic compounds) of a proportion of the liquid-crystalline molecules are oriented at an angle θ (“tilt angle”) between about 80° to 90° relative to the plane of the layer.

The terms “uniform orientation” or “uniform alignment” of an liquid-crystalline material, for example in a layer of the material, mean that the long molecular axes (in case of calamitic compounds) or the short molecular axes (in case of discotic compounds) of the liquid-crystalline molecules are oriented substantially in the same direction. In other words, the lines of liquid-crystalline director are parallel.

The term “processed alignment layer” encompasses alignment layers which were either mechanically treated (rubbing) or exposed to light (preferably, photo-alignment by using polarized UV exposure) to introduce a preferred orientation direction for the liquid crystal molecules. After processing the originally physicochemical energy (e.g. surface energy) and/or the geometrical structure (e.g. grooves or directed side chains of polyimide material by rubbing) of the material is changed. For details on different treatments of alignment layers such as rubbing techniques, etc., c.f. T. Uchida and H. Seki, “Surface Alignment of Liquid Crystals,” Chapter 5 of Liquid Crystals: Applications and Uses, vol. 3, edited by B. Bahadur, World Scientific, 1995 or by Jacques Cognard, “Alignment of Nematic Liquid Crystals and their Mixtures”, Supplement 1, December 1982. Gordon and Breach Science Publishers, Inc., New York.

The term “unprocessed alignment layer” encompasses alignment layers, which were only coated and not further treated, whereby the originally physicochemical energy (e.g. surface energy) and/or the geometrical structure of the material remain unchanged.

The wavelength of light generally referred to in this application is 550 nm, unless explicitly specified otherwise.

The birefringence Δn herein is defined by the following equation

Δn=nₑ−nₒ (6)

wherein nₑ is the extraordinary refractive index and n₀ is the ordinary refractive index, and the average refractive index n_{av.}, is given by the following equation

n_{av.}=[(2nₒ²+nₑ²)/3]^{1/2} (7)

The extraordinary refractive index nₑ and the ordinary refractive index nₒ can be measured using an Abbe refractometer.

For the ULH/USH mode, the dielectric anisotropy (Δε) should be as small as possible, to prevent unwinding of the helix upon application of the addressing voltage. Preferably Δε should be slightly higher than 0 and very preferably be 0.1 or more, but preferably 10 or less, more preferably 7 or less and most preferably 5 or less. In the present application the term “dielectrically positive” is used for compounds or components with Δε>3.0, “dielectrically neutral” with −1.5<Δε<3.0 and “dielectrically negative” with Δε<−1.5. Δε is determined at a frequency of 1 kHz and at 20° C. The dielectric anisotropy of the respective compound is determined from the results of a solution of 10% of the respective individual compound in a nematic host mixture. In case the solubility of the respective compound in the host medium is less than 10% its concentration is reduced by a factor of 2 until the resultant medium is stable enough at least to allow the determination of its properties. Preferably, the concentration is kept at least at 5%, however, in order to keep the significance of the results a high as possible. The capacitance of the test mixtures are determined both in a cell with homeotropic and with homogeneous alignment. The cell gap of both types of cells is approximately 20 μm. The voltage applied is a rectangular wave with a frequency of 1 kHz and a root mean square value typically of 0.5 V to 1.0 V; however, it is always selected to be below the capacitive threshold of the respective test mixture.

Δε is defined as (ε_{∥}−ε_{⊥}), whereas ε_{av.} is (ε_{∥}+2ε_{⊥})/3. The dielectric permittivity of the compounds is determined from the change of the respective values of a host medium upon addition of the compounds of interest. The values are extrapolated to a concentration of the compounds of interest of 100%. A typical host medium is ZLI-4792 or BL-087 both commercially available from Merck, Darmstadt.

For the present invention,

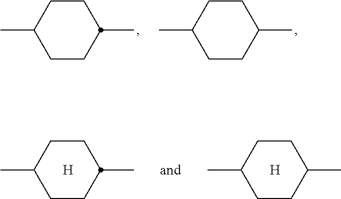

denote trans-1,4-cyclohexylene, and

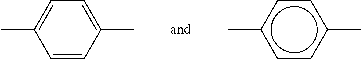

denote 1,4-phenylene.

Furthermore, the definitions as given in C. Tschierske, G. PelzI and S. Diele, Angew. Chem. 2004, 116, 6340-6368 shall apply to non-defined terms related to liquid crystal materials in the instant application.

### DETAILED DESCRIPTION

In accordance with the invention, the substrate material is preferably selected each and independently from another, from polymeric materials, glass or quartz plates.

Suitable and preferred polymeric substrate materials are, for example, films of cyclo olefin polymer (COP), cyclic olefin copolymer (COC), polyester such as polyethyleneterephthalate (PET) or polyethylene-naphthalate (PEN), polyvinylalcohol (PVA), polycarbonate (PC) or triacetylcellulose (TAC), very preferably PET or TAC films. PET films are commercially available for example from DuPont Teijin Films under the trade name Melinex®.

COP films are commercially available for example from ZEON Chemicals L.P. under the trade name Zeonor® or Zeonex®. COC films are commercially available for example from TOPAS Advanced Polymers Inc. under the trade name Topas®.

Preferably, both substrates are glass plates.

The substrates can be kept at a defined separation from one another by, spacers, or projecting structures in the layer of the cholesteric liquid crystalline medium. Typical spacer materials are commonly known to the expert and are preferably selected from plastic, silica, epoxy resins, etc.

Preferably, the substrates are arranged with a separation in the range from approximately 1 μm to approximately 20 μm from another, preferably in the range from approximately 1.5 μm to approximately 10 μm from another, and more preferably in the range from approximately 2 μm to approximately 5 μm from another. The layer of the cholesteric liquid-crystalline medium is thereby located in the interspace.

Preferably, the light modulation element comprises an electrode arrangement, which is capable to allow the application of an electric field, which is substantially perpendicular to the substrate main plane or the cholesteric liquid-crystalline medium layer. Suitable electrode arrangements fulfilling this requirement are commonly known to the expert.

Preferably, the light modulation element comprises an electrode arrangement comprising at least two electrode structures provided on opposing sides of the substrates. Preferably, said electrodes structures are provided as an electrode layer on the entire opposing surface of each substrate and/or the pixel area.

Suitable electrode materials are commonly known to the expert, as for example electrode structures made of metal or metal oxides, such as, for example indium tin oxide (ITO), which is preferred according to the present invention.

Thin films of ITO, for example, are preferably deposited on substrates by physical vapor deposition, electron beam evaporation, or sputter deposition techniques.

Preferably, the electrodes of the light modulation element are associated with a switching element, such as a thin film transistor (TFT) or thin film diode (TFD).

The light modulation element in accordance with the present invention as described above and below, comprises one processed alignment layer and optionally one unprocessed alignment layer.

Preferably, the utilized alignment layer material, either processed or unprocessed, is each and independently capable to induce a homeotropic alignment, tilted homeotropic or planar alignment to the adjacent liquid crystal molecules. Preferably, the utilized alignment layer material is in each case capable to induce a planar alignment to the adjacent liquid crystalline molecules.

Typical homeotropic alignment layer materials are commonly known to the expert, such as, for example, layers made of alkoxysilanes, alkyltrichlorosilanes, CTAB, lecithin or polyimides, preferably polyimides.

Suitable planar polyimides are, for example, AL-3046 or AL-1254 both commercially available from JSR.

Typically, the alignment layer material can be applied onto the substrate or electrode structure by conventional coating techniques like spin coating, roll-coating, dip coating or blade coating, by vapour deposition or conventional printing techniques that are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

The processed alignment layer is, preferably, processed by rubbing techniques known to the skilled person. The rubbing direction is uncritical, preferably, in the range of +/−45°, more preferably in the range of +/−20°, even more preferably, in the range of +/−10, and in particular, in the range of the direction+/−5° with respect to substrates main plane, and defines the preferred orientation of the lying helix

In a preferred embodiment, the light modulation element comprises, preferably consists of, a cholesteric liquid crystalline medium sandwiched between two opposing substrates, each provided with an electrode structure on the opposing sides, wherein one of the substrates is provided with a processed alignment layer adjacent to the cholesteric liquid crystalline medium and the other substrate is without any alignment layer adjacent to the cholesteric liquid crystalline medium.

Accordingly, the light modulation element according to the first preferred embodiment comprises, preferably consists of, the following layer stack:
1^{st} substrate,
1^{st} electrode structure,
cholesteric liquid crystalline medium,
processed alignment layer,
2^{nd} electrode structure, and
2^{nd} substrate.

In second preferred embodiment, the light modulation element comprises, preferably consists of, a cholesteric liquid crystalline medium sandwiched between two opposing substrates, each provided on the opposing sides with an electrode structure, wherein one of the substrates is provided with a processed alignment layer adjacent to the cholesteric liquid crystalline medium and the other substrate is provided with an unprocessed alignment layer adjacent to the cholesteric liquid crystalline medium.

Accordingly, the light modulation element according to the present invention comprises, preferably consists of, the following layer stack:
1^{st} substrate
1^{st} electrode structure,
unprocessed alignment layer,
cholesteric liquid crystalline medium,
processed alignment layer,
2^{nd} electrode structure, and
2^{nd} substrate.

In a further preferred embodiment, in particular in the case where only one (processed) alignment layer is present, the light modulation element optionally comprises at least one dielectric layer, which is provided on the electrode structure which is not covered by an alignment layer.

Typical dielectric layer materials are commonly known to the expert, such as, for example, SiOx, SiNx, Cytop, Teflon, and PMMA.

The dielectric layer materials can be applied onto the substrate or electrode layer by conventional coating techniques like spin coating, roll-coating, blade coating, or vacuum deposition such as PVD or CVD. It can also be applied to the substrate or electrode layer by conventional printing techniques which are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

In a further preferred embodiment of the invention, the light modulation element comprises two or more polarisers, at least one of which is arranged on one side of the layer of the liquid-crystalline medium and at least one of which is arranged on the opposite side of the layer of the liquid-crystalline medium. The layer of the liquid-crystalline medium and the polarisers here are preferably arranged parallel to one another.

The polarisers can be linear polarisers. Preferably, precisely two polarisers are present in the light modulation element. In this case, it is furthermore preferred for the polarisers either both to be linear polarisers. If two linear polarisers are present in the light modulation element, it is preferred in accordance with the invention for the polarisation directions of the two polarisers to be crossed.

It is furthermore preferred in the case where two circular polarisers are present in the light modulation element for these to have the same polarisation direction, i.e. either both are right-hand circular-polarised or both are left-hand circular-polarised.

The polarisers can be reflective or absorptive polarisers. A reflective polariser in the sense of the present application reflects light having one polarisation direction or one type of circular-polarised light, while being transparent to light having the other polarisation direction or the other type of circular-polarised light. Correspondingly, an absorptive polariser absorbs light having one polarisation direction or one type of circular-polarised light, while being transparent to light having the other polarisation direction or the other type of circular-polarised light. The reflection or absorption is usually not quantitative; meaning that complete polarisation of the light passing through the polariser does not take place.

For the purposes of the present invention, both absorptive and reflective polarisers can be employed. Preference is given to the use of polarisers, which are in the form of thin optical films. Examples of reflective polarisers which can be used in the light modulation element according to the invention are DRPF (diffusive reflective polariser film, 3M), DBEF (dual brightness enhanced film, 3M), DBR (layered-polymer distributed Bragg reflectors, as described in U.S. Pat. Nos. 7,038,745 and 6,099,758) and APF (advanced polariser film, 3M).

Examples of absorptive polarisers, which can be employed in the light modulation elements according to the invention, are the Itos XP38 polariser film and the Nitto Denko GU-1220DUN polariser film. An example of a circular polariser, which can be used in accordance with the invention, is the APNCP37-035-STD polariser (American Polarizers). A further example is the CP42 polariser (ITOS).

Accordingly, the light modulation element according to another preferred embodiment comprises, preferably consists of the following layer stack:
polariser,
substrate,
electrode structure,
optional dielectric layer,
cholesteric liquid crystalline medium,
processed alignment layer,
electrode structure,
substrate, and
polariser.

More preferably, the light modulation element according to the present invention comprises, preferably consists of, the following layer stack:
polariser,
substrate,
electrode structure,
unprocessed alignment layer,
cholesteric liquid crystalline medium,
processed alignment layer,
electrode structure,
substrate, and
polariser

The light modulation element may furthermore comprise filters, which block light of certain wavelengths, for example, UV filters. In accordance with the invention, further functional layers commonly known to the expert may also be present, such as, for example, protective films and/or compensation films.

Preferably, the cholesteric liquid crystalline media for the light modulation element according to the present invention comprise at least one bimesogenic compound and at least one chiral compound.

In view of the bimesogenic compounds for the ULH-mode, the Coles group published a paper (Coles et al., 2012 (Physical Review E 2012, 85, 012701)) on the structure-property relationship for dimeric liquid crystals.

Further bimesogenic compounds are known in general from prior art (cf. also Hori, K., Limuro, M., Nakao, A., Toriumi, H., J. Mol. Struc. 2004, 699, 23-29 or GB 2 356 629).

Symmetrical dimeric compounds showing liquid crystalline behaviour are further disclosed in Joo-Hoon Park et al. “Liquid Crystalline Properties of Dimers Having o-, m- and p-Positional Molecular structures”, Bill. Korean Chem. Soc., 2012, Vol. 33, No. 5, pp. 1647-1652.

Similar liquid crystal compositions with short cholesteric pitch for flexoelectric devices are known from EP 0 971 016, GB 2 356 629 and Coles, H. J., Musgrave, B., Coles, M. J., and Willmott, J., J. Mater. Chem., 11, p. 2709-2716 (2001). EP 0 971 016 reports on mesogenic estradiols, which, as such, have a high flexoelectric coefficient.

Typically, for light modulation elements utilizing the ULH mode the optical retardation d*An (effective) of the cholesteric liquid-crystalline medium should preferably be such that the equation

sin 2(π·d·Δn/λ)=1 (8)

wherein

d is the cell gap and

λ is the wavelength of light

is satisfied. The allowance of deviation for the right hand side of equation is +/−3%.

The dielectric anisotropy (Δε) of a suitable cholesteric liquid-crystalline medium should be chosen in that way that unwinding of the helix upon application of the addressing voltage is prevented. Typically, Δε of a suitable liquid crystalline medium is preferably higher than −2, and more preferably 0 or more, but preferably 10 or less, more preferably 5 or less and most preferably 3 or less.

The utilized cholesteric liquid-crystalline medium preferably have a clearing point of approximately 65° C. or more, more preferably approximately 70° C. or more, still more preferably 80° C. or more, particularly preferably approximately 85° C. or more and very particularly preferably approximately 90° C. or more.

The nematic phase of the utilized cholesteric liquid-crystalline medium according to the invention preferably extends at least from approximately 0° C. or less to approximately 65° C. or more, more preferably at least from approximately −20° C. or less to approximately 70° C. or more, very preferably at least from approximately −30° C. or less to approximately 70° C. or more and in particular at least from approximately −40° C. or less to approximately 90° C. or more. In individual preferred embodiments, it may be necessary for the nematic phase of the media according to the invention to extend to a temperature of approximately 100° C. or more and even to approximately 110° C. or more.

Typically, the cholesteric liquid-crystalline medium utilized in a light modulation element in accordance with the present invention comprises one or more bimesogenic compounds, which are preferably selected from the group of compounds of formulae A-I to A-III,

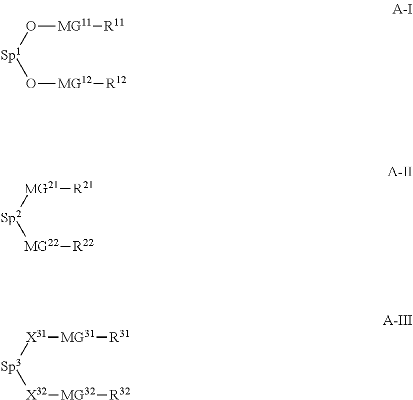

and wherein
R¹¹ and R¹², R²¹ and R²², and R³¹ and R³² are each independently H, F, Cl, CN, NCS or a straight-chain or branched alkyl group with 1 to 25 C atoms which may be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
MG¹¹ and MG¹², MG²¹ and MG²² and MG³¹ and MG³² are each independently a mesogenic group,
Sp¹, Sp² and Sp³ are each independently a spacer group comprising 5 to 40 C atoms, wherein one or more non-adjacent CH₂ groups, with the exception of the CH₂ groups of Sp¹ linked to O-MG¹¹ and/or O-MG¹², of Sp² linked to MG²¹ and/or MG²² and of Sp³ linked to X³¹ and X³², may also be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—, however in such a way that no two O-atoms are adjacent to one another, no two —CH═CH— groups are adjacent to each other, and no two groups selected from —O—CO—, —S—CO—, —O—COO—, —CO—S—, —CO—O— and —CH═CH— are adjacent to each other and
X³¹ and X³² are independently from one another a linking group selected from —CO—O—, —O—CO—, —CH═CH—, —C≡C— or —S—, and, alternatively, one of them may also be either —O— or a single bond, and, again alternatively, one of them may be —O— and the other one a single bond.

Preferably used are compounds of formulae A-I to A-III wherein
Sp¹, Sp² and Sp³ are each independently —(CH₂)ₙ— with
n an integer from 1 to 15, most preferably an uneven integer, wherein one or more —CH₂— groups may be replaced by —CO—.

Especially compounds of formula A-III wherein
—X³¹-Sp³-X³²— is -Sp³-O—, -Sp³-CO—O—, -Sp³-O—CO—, —O-Sp³-, —O-Sp³-CO—O—, —O-Sp³-O—CO—, —O—CO-Sp³-O—, —O—CO-Sp³-O— CO—, —CO—O-Sp³-O— or —CO—O-Sp³-CO—O—, however under the condition that in —X³¹-Sp³-X³²— no two O-atoms are adjacent to one another, no two —CH═CH— groups are adjacent to each other and no two groups selected from —O—CO—, —S—CO—, —O—COO—, —CO—S—, —CO—O— and —CH═CH— are adjacent to each other.

Further preferred are compounds of formula A-I in which
MG¹¹ and MG¹² are independently from one another -A¹¹-(Z¹-A¹²)ₘ-

wherein
Z¹ is —COO—, —OCO—, —O—CO—O—, —OCH₂—, —CH₂O—, —CH₂CH₂—, —(CH₂)₄—, —CF₂CF₂—, —CH═CH—, —CF═CF—, —CH═CH—COO—, —OCO—CH═CH—, —C≡C— or a single bond,
A¹¹ and A¹² are each independently in each occurrence 1,4-phenylene, wherein in addition one or more CH groups may be replaced by N, trans-1,4-cyclo-hexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1]decane-2,8-diyl, it being possible for all these groups to be unsubstituted, mono-, di-, tri- or tetrasubstituted with F, Cl, CN or alkyl, alkoxy, alkylcarbonyl or alkoxycarbonyl groups with 1 to 7 C atoms, wherein one or more H atoms may be substituted by F or Cl, and
   m is 0, 1, 2 or 3.

Further preferred are compounds of formula A-II in which
MG²¹ and MG²² are independently from one another -A²¹-(Z²-A²²)ₘ-

wherein
Z² is —COO—, —OCO—, —O—CO—O—, —OCH₂—, —CH₂O—, —CH₂CH₂—, —(CH₂)₄—, —CF₂CF₂—, —CH═CH—, —CF═CF—, —CH═CH—COO—, —OCO—CH═CH—, —C≡C— or a single bond,
A²¹ and A²² are each independently in each occurrence 1,4-phenylene, wherein in addition one or more CH groups may be replaced by N, trans-1,4-cyclo-hexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1]decane-2,8-diyl, it being possible for all these groups to be unsubstituted, mono-, di-, tri- or tetrasubstituted with F, Cl, CN or alkyl, alkoxy, alkylcarbonyl or alkoxycarbonyl groups with 1 to 7 C atoms, wherein one or more H atoms may be substituted by F or Cl, and
m is 0, 1, 2 or 3.

Further preferred are compounds of formula A-III in which
MG³¹ and MG³² are independently from one another -A³¹-(Z³-A³²)ₘ-

wherein
Z³ is —COO—, —OCO—, —O—CO—O—, —OCH₂—, —CH₂O—, —CH₂CH₂—, —(CH₂)₄—, —CF₂CF₂—, —CH═CH—, —CF═CF—, —CH═CH—COO—, —OCO—CH═CH—, —C≡C— or a single bond,
A³¹ and A³² are each independently in each occurrence 1,4-phenylene, wherein in addition one or more CH groups may be replaced by N, trans-1,4-cyclo-hexylene in which, in addition, one or two non-adjacent CH₂ groups may be replaced by O and/or S, 1,4-cyclohexenylene, 1,4-bicyclo-(2,2,2)-octylene, piperidine-1,4-diyl, naphthalene-2,6-diyl, decahydro-naphthalene-2,6-diyl, 1,2,3,4-tetrahydro-naphthalene-2,6-diyl, cyclobutane-1,3-diyl, spiro[3.3]heptane-2,6-diyl or dispiro[3.1.3.1]decane-2,8-diyl, it being possible for all these groups to be unsubstituted, mono-, di-, tri- or tetrasubstituted with F, Cl, CN or alkyl, alkoxy, alkylcarbonyl or alkoxycarbonyl groups with 1 to 7 C atoms, wherein one or more H atoms may be substituted by F or Cl, and
m is 0, 1, 2 or 3.

Preferably, the compounds of formula A-III are asymmetric compounds, preferably having different mesogenic groups MG³¹ and MG³².

Generally preferred are compounds of formulae A-I to A-III in which the dipoles of the ester groups present in the mesogenic groups are all oriented in the same direction, i.e. all —CO—O— or all —O—CO—.

Especially preferred are compounds of formulae A-I and/or A-II and/or A-III wherein the respective pairs of mesogenic groups (MG¹¹ and MG¹²) and (MG²¹ and MG²²) and (MG³¹ and MG³²) at each occurrence independently from each other comprise one, two or three six-atomic rings, preferably two or three six-atomic rings.

In particular preferred are compounds of formulae A-I and/or A-II and/or A-III that do not comprise a polymerisable group such as acrylate or methacrylate groups.

A smaller group of preferred mesogenic groups is listed below. For reasons of simplicity, Phe in these groups is 1,4-phenylene, PheL is a 1,4-phenylene group which is substituted by 1 to 4 groups L, with L being preferably F, Cl, CN, OH, NO₂ or an optionally fluorinated alkyl, alkoxy or alkanoyl group with 1 to 7 C atoms, very preferably F, Cl, CN, OH, NO₂, CH₃, C₂H₅, OCH₃, OC₂H₅, COCH₃, COC₂H₅, COOCH₃, COOC₂H₅, CF₃, OCF₃, OCHF₂, OC₂F₅, in particular F, Cl, CN, CH₃, C₂H₅, OCH₃, COCH₃ and OCF₃, most preferably F, Cl, CH₃, OCH₃ and COCH₃ and Cyc is 1,4-cyclohexylene. This list comprises the sub-formulae shown below as well as their mirror images

-Phe-Z-Phe- II-1

-Phe-Z-Cyc- II-2

-Cyc-Z-Cyc- II-3

-PheL-Z-Phe- II-4

-PheL-Z-Cyc- II-5

-PheL-Z-PheL- II-6

-Phe-Z-Phe-Z-Phe- II-7

-Phe-Z-Phe-Z-Cyc- II-8

-Phe-Z-Cyc-Z-Phe- II-9

-Cyc-Z-Phe-Z-Cyc- II-10

-Phe-Z-Cyc-Z-Cyc- II-11

-Cyc-Z-Cyc-Z-Cyc- II-12

-Phe-Z-Phe-Z-PheL- II-13

-Phe-Z-PheL-Z-Phe- II-14

-PheL-Z-Phe-Z-Phe- II-15

-PheL-Z-Phe-Z-PheL- II-16

-PheL-Z-PheL-Z-Phe- II-17

-PheL-Z-PheL-Z-PheL- II-18

-Phe-Z-PheL-Z-Cyc- II-19

-Phe-Z-Cyc-Z-PheL- II-20

-Cyc-Z-Phe-Z-PheL- II-21

-PheL-Z-Cyc-Z-PheL- II-22

-PheL-Z-PheL-Z-Cyc- II-23

-PheL-Z-Cyc-Z-Cyc- II-24

-Cyc-Z-PheL-Z-Cyc- II-25

Particularly preferred are the sub formulae II-1, II-4, II-6, II-7, II-13, II-14, 11-15, II-16, II-17 and II-18.

In these preferred groups, Z in each case independently has one of the meanings of Z¹ as given above for MG²¹ and MG²². Preferably Z is —COO—, —OCO—, —CH₂CH₂—, —C≡C— or a single bond, especially preferred is a single bond.

Very preferably the mesogenic groups MG¹¹ and MG¹², MG²¹ and MG²² and MG³¹ and MG³² are each and independently selected from the following formulae and their mirror images

Very preferably, at least one of the respective pairs of mesogenic groups MG¹¹ and MG¹², MG²¹ and MG²² and MG³¹ and MG³² is, and preferably, both of them are each and independently, selected from the following formulae IIa to IIn (the two reference Nos. “II i” and “II I” being deliberately omitted to avoid any confusion) and their mirror images

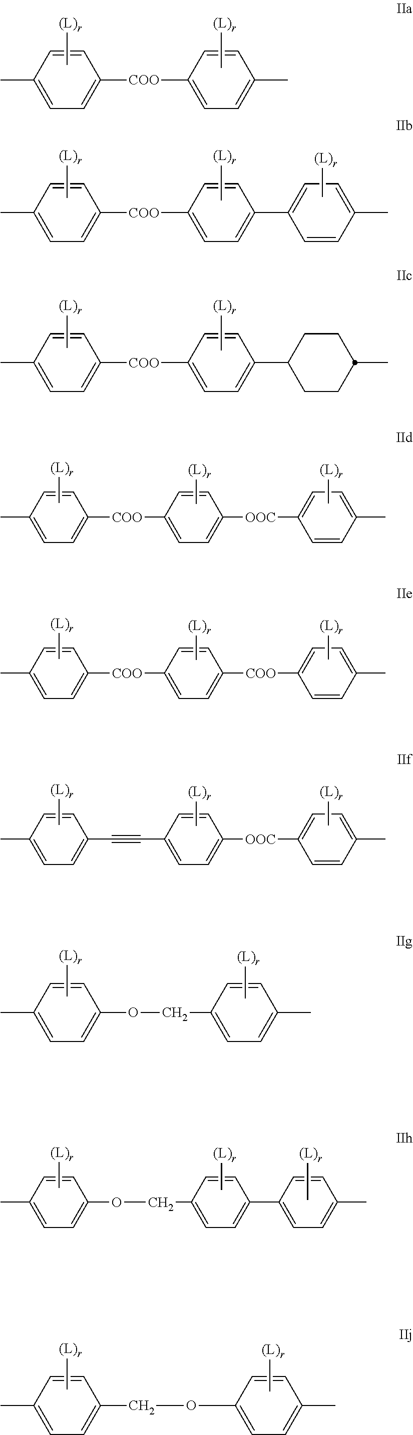

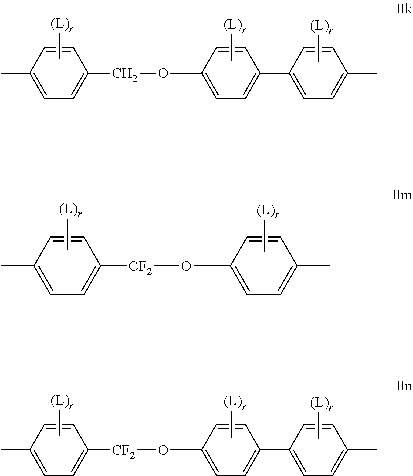

wherein

L is in each occurrence independently of each other F or Cl, preferably F and

r is in each occurrence independently of each other 0, 1, 2 or 3, preferably 0, 1 or 2.

The group

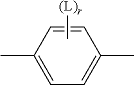

in these preferred formulae is very preferably denoting

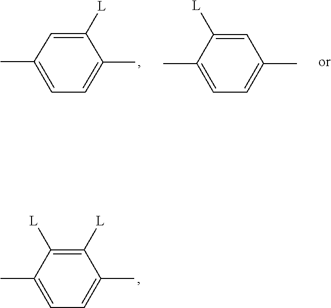

furthermore

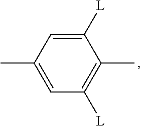

Particularly preferred are the sub formulae IIa, IId, IIg, IIh, IIi, IIk and IIo, in particular the sub formulae IIa and IIg.

In case of compounds with a non-polar group, R¹, R¹², R²¹, R²², R³¹, and R³² are preferably alkyls with up to 15 C atoms or alkoxy with 2 to 15 C atoms.

If R¹¹ and R¹², R²¹ and R²² and R³¹ and R³² are an alkyl or alkoxy radical, i.e. where the terminal CH₂ group is replaced by —O—, this may be straight chain or branched. It is preferably straight-chain, has 2, 3, 4, 5, 6, 7 or 8 carbon atoms and accordingly is preferably ethyl, propyl, butyl, pentyl, hexyl, heptyl, octyl, ethoxy, propoxy, butoxy, pentoxy, hexoxy, heptoxy, or octoxy, furthermore methyl, nonyl, decyl, undecyl, dodecyl, tridecyl, tetradecyl, pentadecyl, nonoxy, decoxy, undecoxy, dodecoxy, tridecoxy or tetradecoxy, for example.

Oxaalkyl, i.e. where one CH₂ group is replaced by —O—, is preferably straight-chain 2-oxapropyl (=methoxymethyl), 2-(=ethoxymethyl) or 3-oxabutyl (=2-methoxyethyl), 2-, 3-, or 4-oxapentyl, 2-, 3-, 4-, or 5-oxahexyl, 2-, 3-, 4-, 5-, or 6-oxaheptyl, 2-, 3-, 4-, 5-, 6- or 7-oxaoctyl, 2-, 3-, 4-, 5-, 6-, 7- or 8-oxanonyl or 2-, 3-, 4-, 5-, 6-, 7-, 8- or 9-oxadecyl, for example.

In case of a compounds with a terminal polar group, R¹¹ and R¹², R²¹ and R²² and R³¹ and R³² are selected from CN, NO₂, halogen, OCH₃, OCN, SCN, COR^{x}, COOR^{x} or a mono- oligo- or polyfluorinated alkyl or alkoxy group with 1 to 4 C atoms. R^{x} is optionally fluorinated alkyl with 1 to 4, preferably 1 to 3 C atoms. Halogen is preferably F or Cl.

Especially preferably R¹¹ and R¹², R²¹ and R²² and R³¹ and R³² in formulae A-I, A-II, respectively A-III are selected of H, F, Cl, CN, NO₂, OCH₃, COCH₃, COC₂H₅, COOCH₃, COOC₂H₅, CF₃, C₂F₅, OCF₃, OCHF₂, and OC₂F₅, in particular of H, F, Cl, CN, OCH₃ and OCF₃, especially of H, F, CN and OCF₃.

In addition, compounds of formulae A-I, A-II, respectively A-III containing an achiral branched group R¹¹ and/or R²¹ and/or R³¹ may occasionally be of importance, for example, due to a reduction in the tendency towards crystallization. Branched groups of this type generally do not contain more than one chain branch. Preferred achiral branched groups are isopropyl, isobutyl (=methylpropyl), isopentyl (=3-methylbutyl), isopropoxy, 2-methyl-propoxy and 3-methylbutoxy.

The spacer groups Sp¹, Sp² and Sp³ are preferably a linear or branched alkylene group having 5 to 40 C atoms, in particular 5 to 25 C atoms, very preferably 5 to 15 C atoms, in which, in addition, one or more non-adjacent and non-terminal CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

“Terminal” CH₂ groups are those directly bonded to the mesogenic groups. Accordingly, “non-terminal” CH₂ groups are not directly bonded to the mesogenic groups R¹¹ and R¹², R²¹ and R²² and R³¹ and R³².

Typical spacer groups are for example —(CH₂)ₒ—, —(CH₂CH₂O)ₚ—CH₂CH₂—, with o being an integer from 5 to 40, in particular from 5 to 25, very preferably from 5 to 15, and p being an integer from 1 to 8, in particular 1, 2, 3 or 4.

Preferred spacer groups are pentylene, hexylene, heptylene, octylene, nonylene, decylene, undecylene, dodecylene, octadecylene, diethyleneoxyethylene, dimethyleneoxybutylene, pentenylene, heptenylene, nonenylene and undecenylene, for example.

Especially preferred are compounds of formulae A-I, A-II and A-III wherein Sp¹, Sp², respectively Sp³ are alkylene with 5 to 15 C atoms. Straight-chain alkylene groups are especially preferred.

Preferred are spacer groups with even numbers of a straight-chain alkylene having 6, 8, 10, 12 and 14 C atoms.

In another embodiment of the present invention are the spacer groups preferably with odd numbers of a straight-chain alkylene having 5, 7, 9, 11, 13 and 15 C atoms. Very preferred are straight-chain alkylene spacers having 5, 7, or 9 C atoms.

Especially preferred are compounds of formulae A-I, A-II and A-III wherein Sp¹, Sp², respectively Sp³ are completely deuterated alkylene with 5 to 15 C atoms. Very preferred are deuterated straight-chain alkylene groups.

Most preferred are partially deuterated straight-chain alkylene groups. Preferred are compounds of formula A-I wherein the mesogenic groups R¹¹-MG¹¹- and R¹²-MG¹-are different. Especially preferred are compounds of formula A-I wherein R¹-MG¹¹- and R¹²-MG¹²- in formula A-I are identical.

Preferred compounds of formula A-I are selected from the group of compounds of formulae A-I-1 to A-I-3

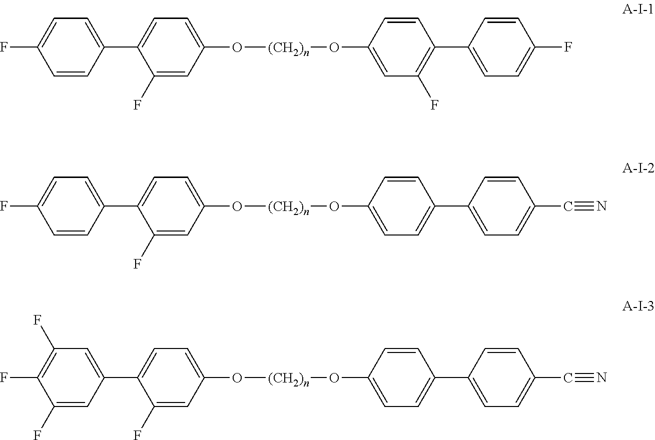

wherein the parameter n has the meaning given above and preferably is 3, 5, 7 or 9, more preferably 5, 7 or 9.

Preferred compounds of formula A-II are selected from the group of compounds of formulae A-II-1 to A-II-4

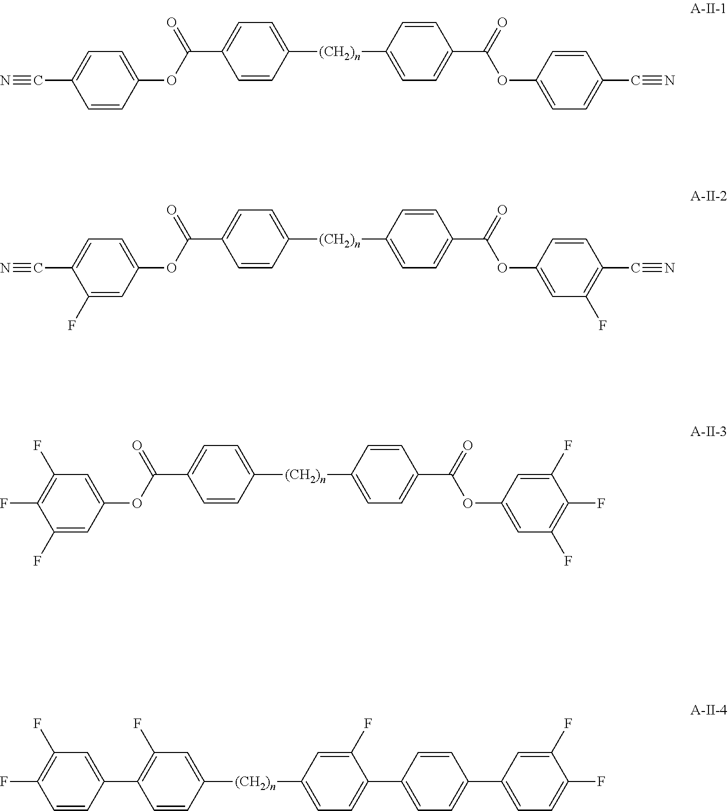

wherein the parameter n has the meaning given above and preferably is 3, 5, 7 or 9, more preferably 5, 7 or 9.

Preferred compounds of formula A-III are selected from the group of compounds of formulae A-III-1 to A-III-11

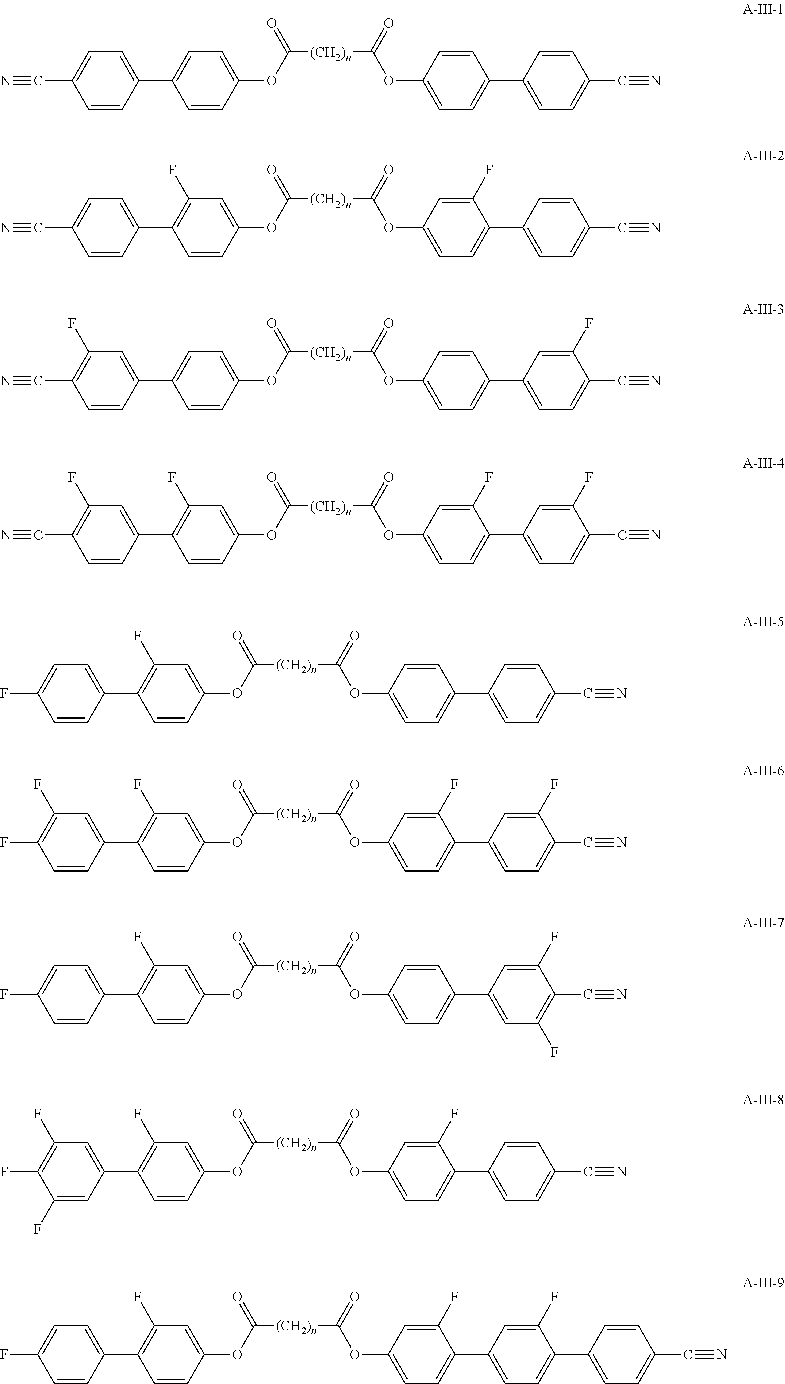

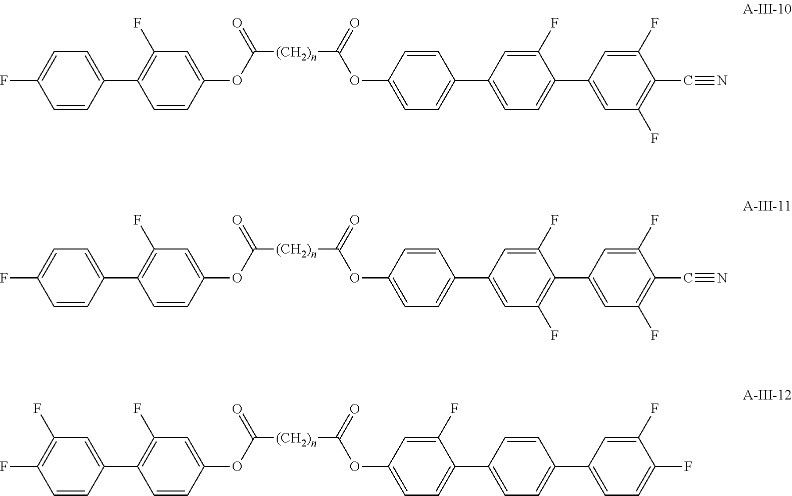

wherein the parameter n has the meaning given above and preferably is 3, 5, 7 or 9, more preferably 5, 7 or 9.

Particularly preferred exemplary compounds of formulae A-I are the following compounds:

symmetrical ones:

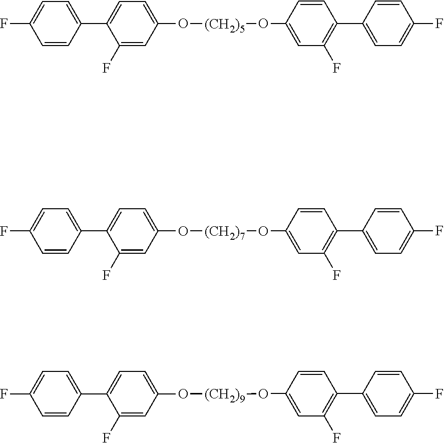

and non-symmetrical ones:

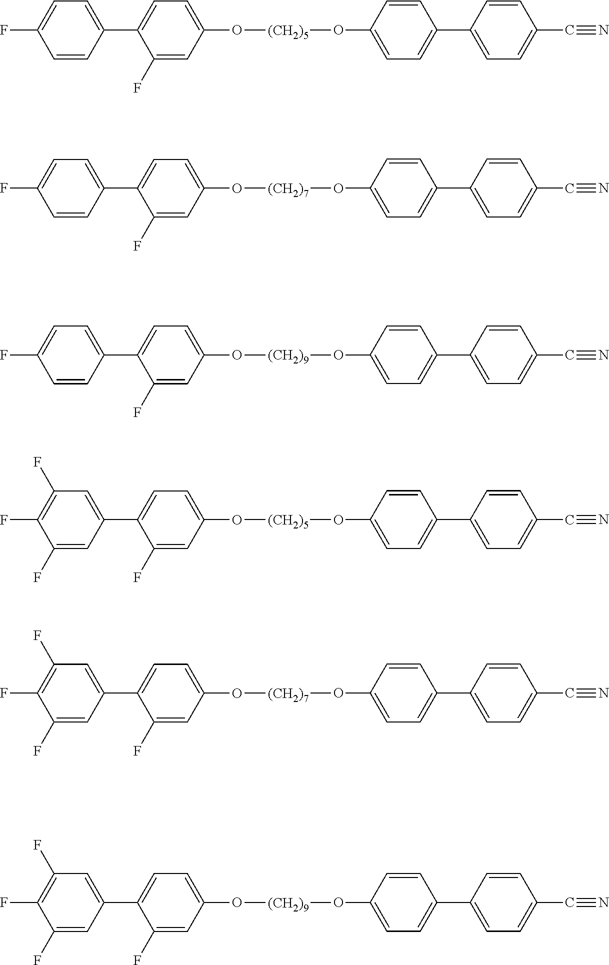

Particularly preferred exemplary compounds of formulae A-II are the following compounds:

symmetrical ones:

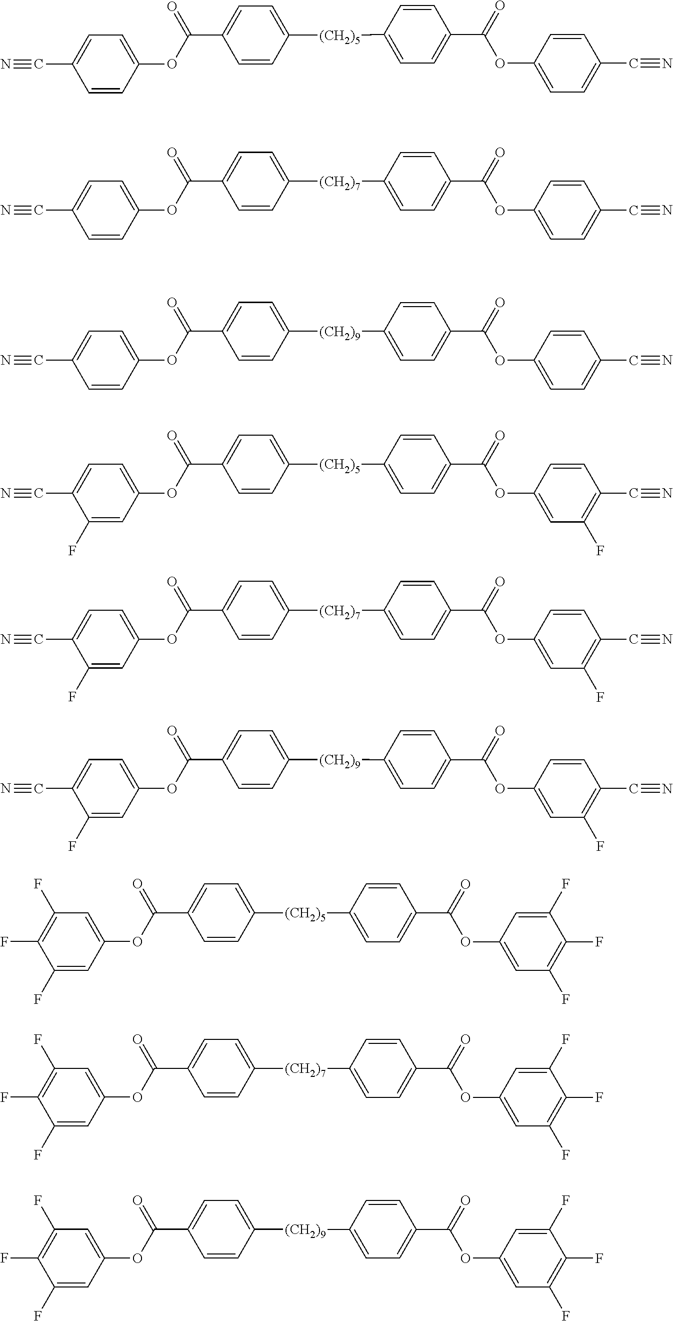

and non-symmetrical ones:

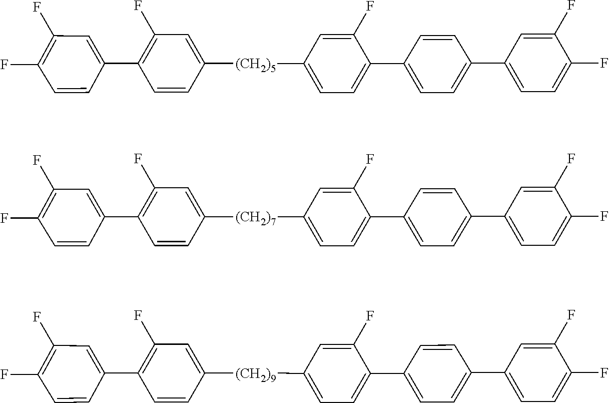

Particularly preferred exemplary compounds of formulae A-III are the following compounds:

symmetrical ones:

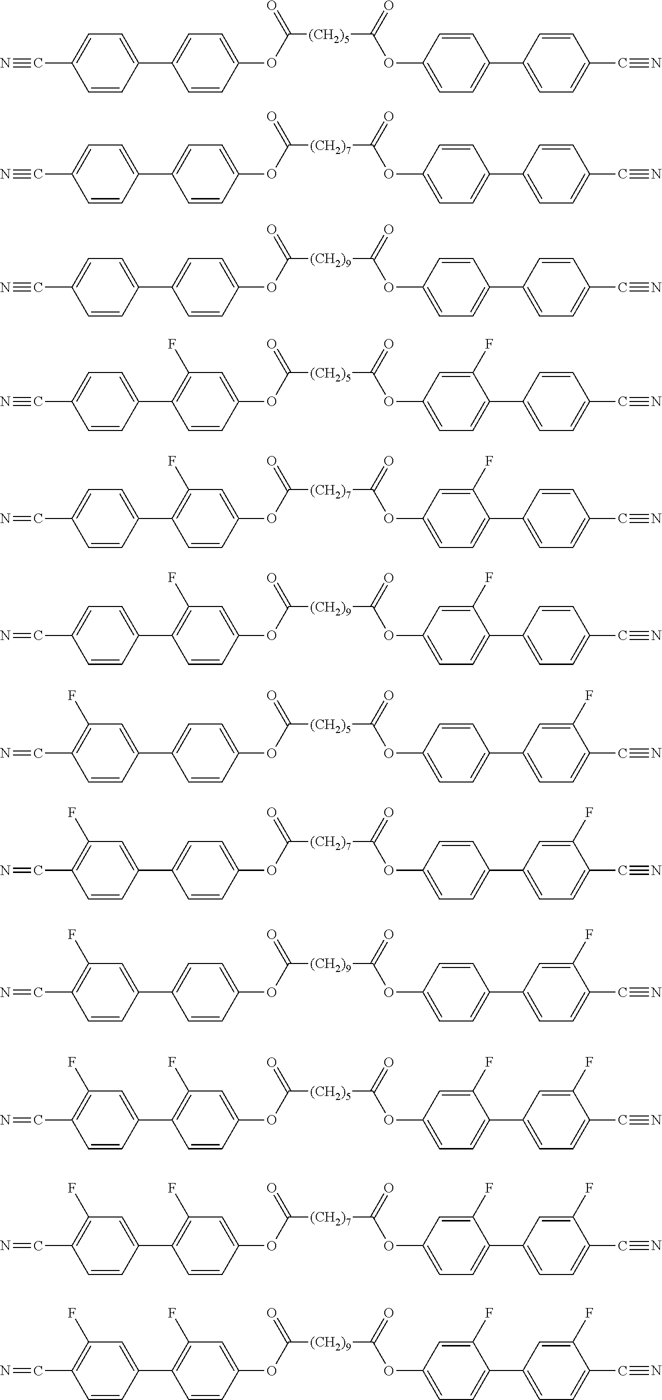

and non-symmetrical ones:

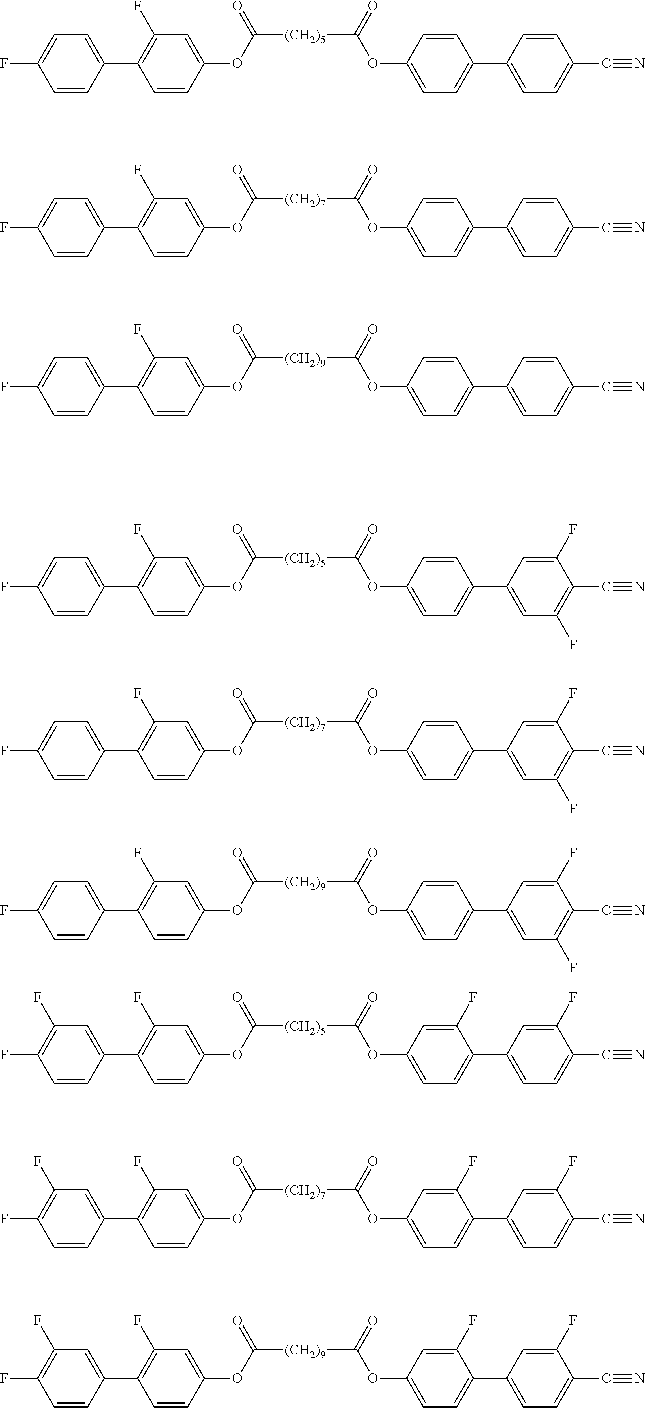

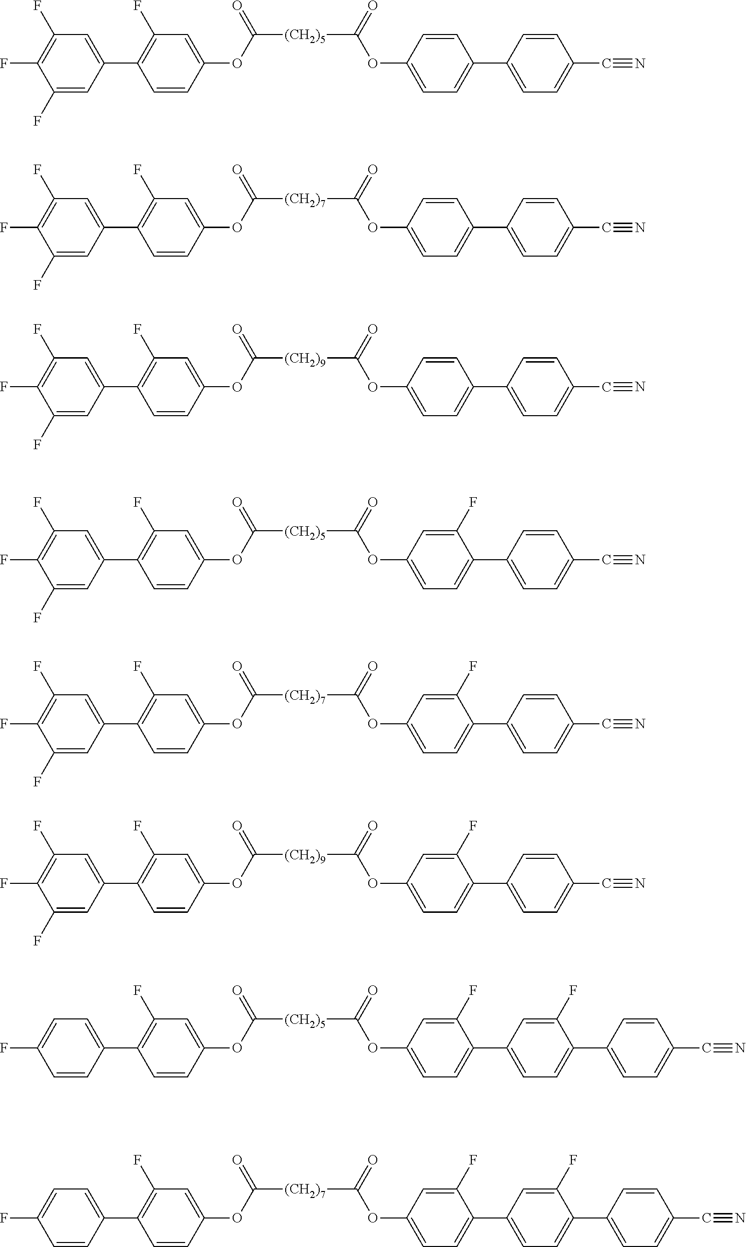

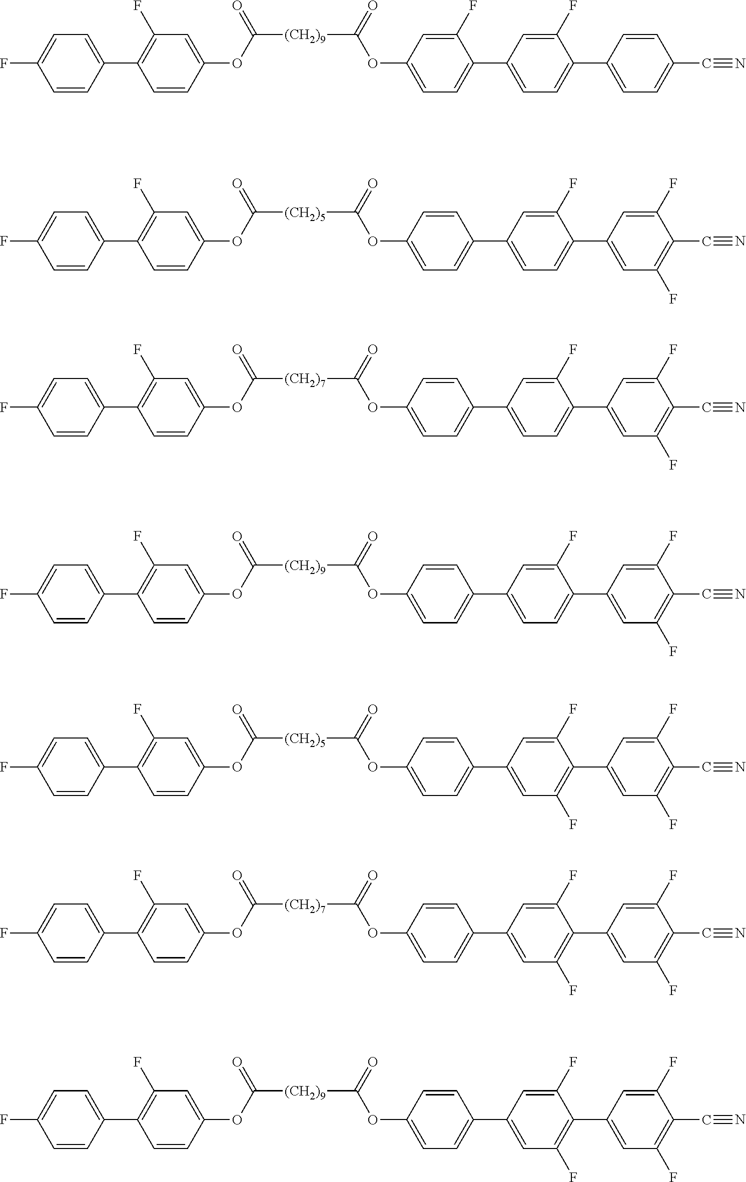

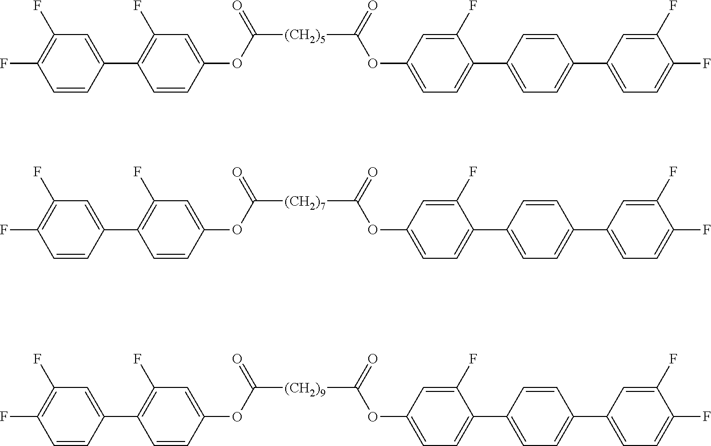

The bimesogenic compounds of formula A-I to A-III are particularly useful in flexoelectric liquid crystal displays as they can easily be aligned into macroscopically uniform orientation, and lead to high values of the elastic 30 constant k₁₁ and a high flexoelectric coefficient e in the applied liquid crystalline media.

The compounds of formulae A-I to A-III can be synthesized according to or in analogy to methods which are known per se and which are described in standard works of organic chemistry such as, for example, Houben-Weyl, Methoden der organischen Chemie, Thieme-Verlag, Stuttgart.

In a preferred embodiment, the cholesteric liquid crystalline medium optionally comprise one or more nematogenic compounds, which are preferably selected from the group of compounds of formulae B-I to B-III

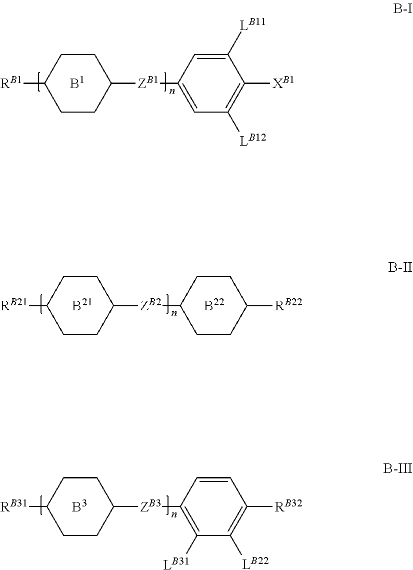

wherein
L^{B11} to L^{B31} are independently H or F, preferably one is H and the other H or F and most preferably both are H or both are F.
RB¹ RB²¹ and RB²² and R^{B31} and R^{B32} are each independently H, F, Cl, CN, NCS or a straight-chain or branched alkyl group with 1 to 25 C atoms which may be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C—in such a manner that oxygen atoms are not linked directly to one another,
X^{B1} is F, Cl, CN, NCS, preferably CN,
Z^{B1}, Z^{B2} and Z^{B3} are in each occurrence independently —CH₂—CH₂—, —CO—O—, —O—CO—, —CF₂—O—, —O— CF₂—, —CH═CH—, —C≡C— or a single bond, preferably —CH₂—CH₂—, —CO—O—, —CH═CH—, —C≡C— or a single bond,

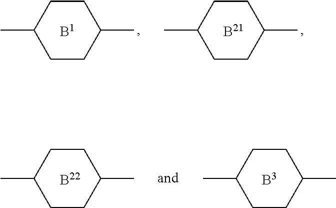

are in each occurrence independently

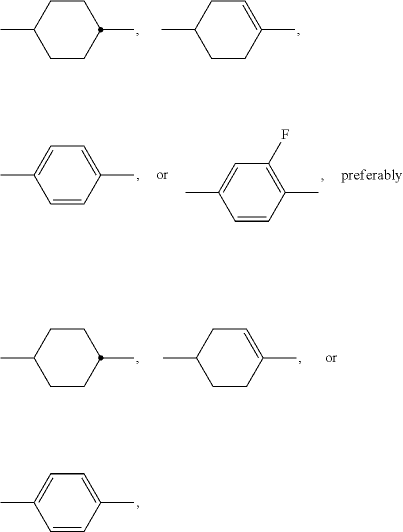

alternatively one or more of

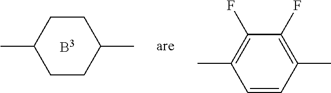

and
n is 1, 2 or 3, preferably 1 or 2.

Further preferred are cholesteric liquid-crystalline media comprising one or more nematogens of formula B-I selected from the group of formulae B-I-1 to B-I-5, preferably selected from the group of formulae of formula, B-I-1, B-I-2, B-I-3 B-I-5 and/or B-I-6,

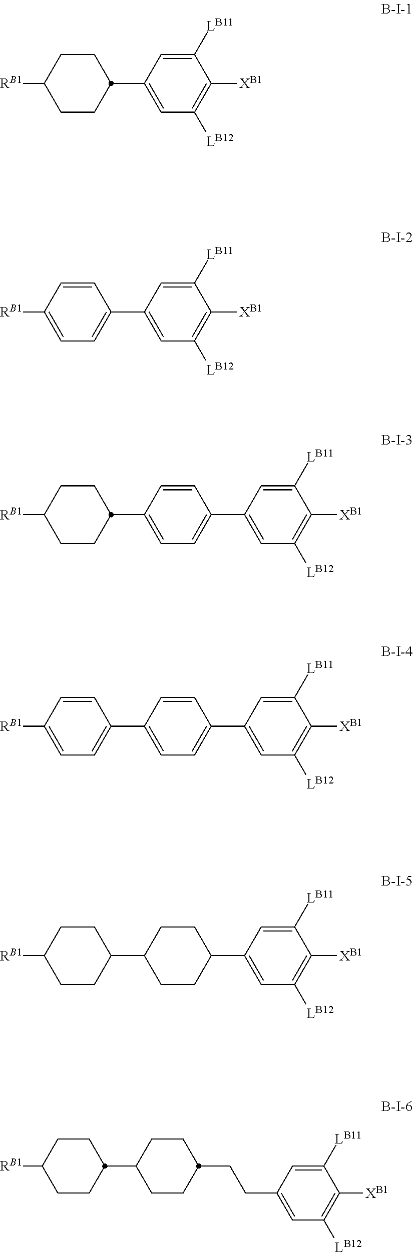

wherein the parameters have the meanings given above and preferably
R^{B1} is alkyl, alkoxy, alkenyl or alkenyloxy with up to 12 C atoms,
X^{B1} is F, Cl, CN, NCS, OCF₃, preferably CN, OCF₃ or F, and
L^{B11} and L^{B12} are independently H or F, preferably one is H and the other H or F and most preferably both are H.

Further preferred are cholesteric liquid-crystalline media comprising one or more nematogens of formula B-II selected from the from the group of formulae B-II-1 to B-II-5, preferably of formula B-II-1 and/or B-II-5,

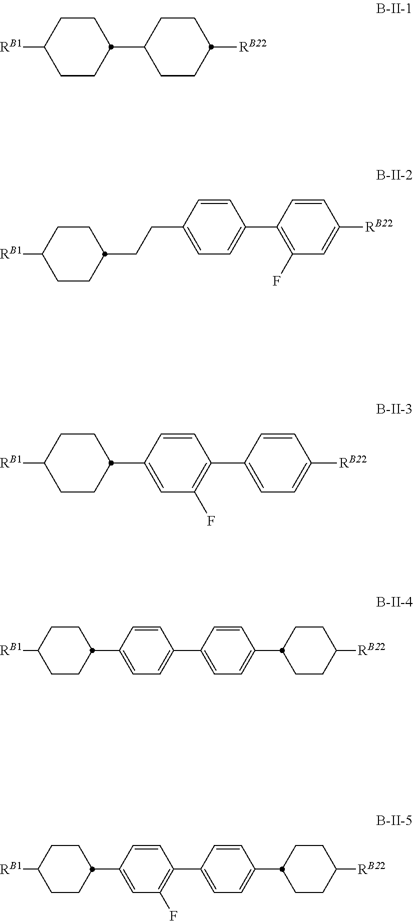

wherein the parameters have the meanings given above and preferably
R^{B21} and R^{B22} are independently alkyl, alkoxy, alkenyl or alkenyloxy with up to 12 C atoms, more preferably R^{B21} is alkyl and R^{B22} is alkyl, alkoxy or alkenyl and in formula B-II-1 most preferably alkenyl, in particular vinyl or 1-propenyl, and in formula B-II-2, most preferably alkyl.

Further preferred are cholesteric liquid-crystalline media comprising one or more nematogens of formula B-III, preferably selected from the group compounds of formulae B-III-1 to B-III-10, most preferably of formula B-III-10,

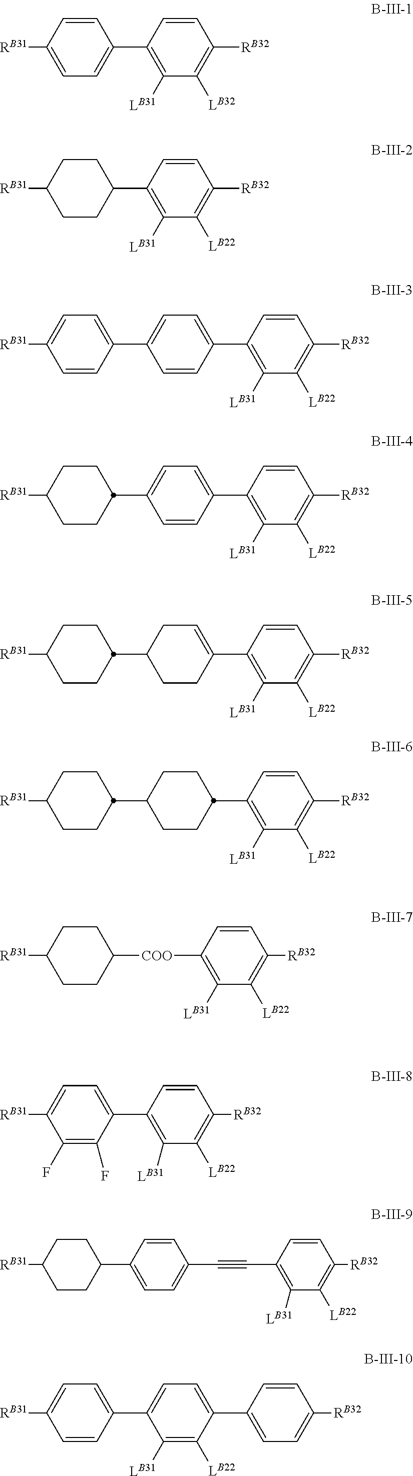

wherein the parameters have the meanings given above and preferably
R^{B31} and R^{B32} are independently alkyl, alkoxy, alkenyl or alkenyloxy with up to 12 C atoms, more preferably R^{B31} is alkyl and R^{B32} is alkyl or alkoxy and most preferably alkoxy, and
L^{B22} and L^{B31} L^{B32} are independently H or F, preferably one is F and the other H or F and most preferably both are F.

The compounds of formulae B-I to B-III are either known to the expert and can be synthesized according to or in analogy to methods which are known per se and which are described in standard works of organic chemistry such as, for example, Houben-Weyl, Methoden der organischen Chemie, Thieme-Verlag, Stuttgart.

Suitable cholesteric liquid-crystalline media for the ULH mode comprise one or more chiral compounds with a suitable helical twisting power (HTP), in particular those disclosed in WO 98/00428.

Preferably, the chiral compounds are selected from the group of compounds of formulae C-I to C-III,

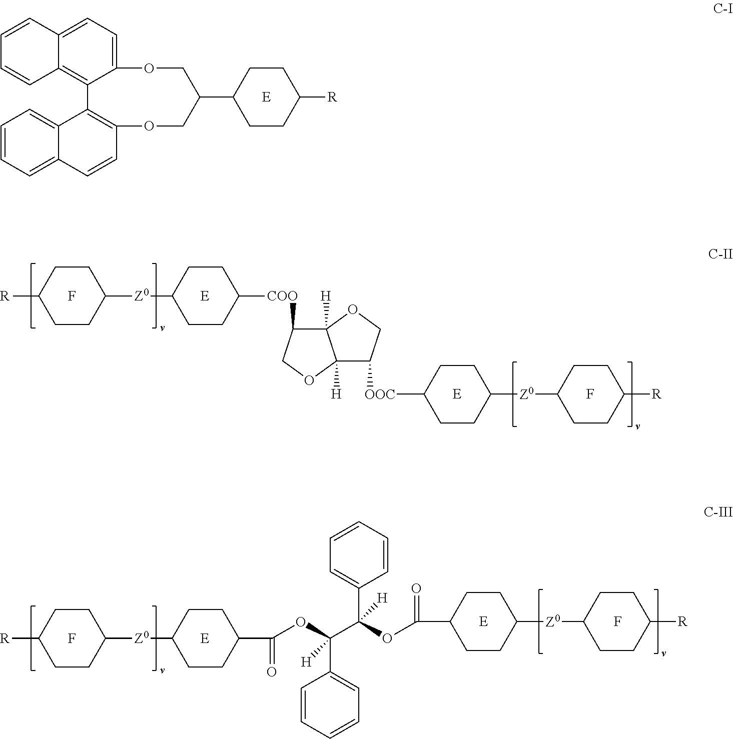

the latter ones including the respective (S,S) enantiomers,

wherein E and F are each independently 1,4-phenylene or trans-1,4-cyclo-hexylene, v is 0 or 1, Z⁰ is —COO—, —OCO—, —CH₂CH₂— or a single bond, and R is alkyl, alkoxy or alkanoyl with 1 to 12 C atoms.

Particularly preferred cholesteric liquid-crystalline media comprise at least one or more chiral compounds which themselves do not necessarily have to show a liquid crystalline phase and give good uniform alignment themselves.

The compounds of formula C-III and their synthesis are described in WO 98/00428. Especially preferred is the compound CD-1, as shown in table D below. The compounds of formula C-III and their synthesis are described in GB 2 328 207.

Further, typically used chiral compounds are e.g. the commercially available R/S-5011, CD-1, R/S-811 and CB-15 (from Merck KGaA, Darmstadt, Germany).

The above mentioned chiral compounds R/S-5011 and CD-1 and the (other) compounds of formulae C-I, C-II and C-III exhibit a very high helical twisting power (HTP), and are therefore particularly useful for the purpose of the present invention.

The cholesteric liquid-crystalline medium preferably comprises preferably 1 to 5, in particular 1 to 3, very preferably 1 or 2 chiral compounds, preferably selected from the above formula C-III, in particular CD-1, and/or formula C—III and/or R-5011 or S-5011, very preferably, the chiral compound is R-5011, S-5011 or CD-1.

The amount of chiral compounds in the cholesteric liquid-crystalline medium is preferably from 1 to 20%, more preferably from 1 to 15%, even more preferably 1 to 10%, and most preferably 1 to 5%, by weight of the total mixture.

In a further preferred embodiment, a small amount (for example 0.3% by weight, typically <1% by weight) of a polymerisable compound is added to the above described cholesteric liquid-crystalline medium and, after introduction into the light modulation element, is polymerised or cross-linked in situ, usually by UV photopolymerisation. The addition of polymerisable mesogenic or liquid-crystalline compounds, also known as “reactive mesogens” (RMs), to the LC mixture has been proven particularly suitable in order further to stabilise the ULH texture (e.g. Lagerwall et al., Liquid Crystals 1998, 24, 329-334.).

Suitable polymerisable liquid-crystalline compounds are preferably selected from the group of compounds of formula D,

P-Sp-MG-R⁰ D

wherein
P is a polymerisable group,
Sp is a spacer group or a single bond,
MG is a rod-shaped mesogenic group, which is preferably selected of formula M,
M is -(A^{D21}-Z^{D21})ₖ-A^{D22}-(Z^{D22}-A^{D23})ₗ-,
A^{D21} to A^{D23} are in each occurrence independently of one another an aryl-, heteroaryl-, heterocyclic- or alicyclic group optionally being substituted by one or more identical or different groups L, preferably 1,4-cyclohexylene or 1,4-phenylene, 1,4 pyridine, 1,4-pyrimidine, 2,5-thiophene, 2,6-dithieno[3,2-b:2′,3′-d]thiophene, 2,7-fluorine, 2,6-naphtalene, 2,7-phenanthrene optionally being substituted by one or more identical or different groups L,
Z^{D21} and Z^{D22} are in each occurrence independently from each other, —O—, —S—, —CO—, —COO—, —OCO—, —S—CO—, —CO—S—, —O—COO—, —CO—NR⁰¹—, —NR⁰¹—CO—, —NR⁰¹—CO—NR⁰², —NR⁰¹—CO—O—, —O—CO—NR⁰¹—, —OCH₂—, —CH₂O—, —SCH₂—, —CH₂S—, —CF₂O—, —OCF₂—, —CF₂S—, —SCF₂—, —CH₂CH₂—, —(CH₂)₄—, —CF₂CH₂—, —CH₂CF₂—, —CF₂CF₂—, —CH═N—, —N═CH—, —N═N—, —CH═CR⁰¹—, —CY⁰¹═CY⁰²—, —C≡C—, —CH═CH—COO—, —OCO—CH═CH—, or a single bond, preferably —COO—, —OCO—, —CO—O—, —O—CO—, —OCH₂—, —CH₂O—, —CH₂CH₂—, —(CH₂)₄—, —CF₂CH₂—, —CH₂CF₂—, —CF₂CF₂—, —C≡C—, —CH═CH—COO—, —OCO— CH═CH—, or a single bond,
L is in each occurrence independently of each other F or Cl,
R⁰ is H, alkyl, alkoxy, thioalkyl, alkylcarbonyl, alkoxycarbonyl, alkylcarbonyloxy or alkoxycarbonyloxy with 1 to 20 C atoms more, preferably 1 to 15 C atoms which are optionally fluorinated, or is Y⁰ or P-Sp-,
Y⁰ is F, Cl, CN, NO₂, OCH₃, OCN, SCN, optionally fluorinated alkylcarbonyl, alkoxycarbonyl, alkylcarbonyloxy or alkoxycarbonyloxy with 1 to 4 C atoms, or mono- oligo- or polyfluorinated alkyl or alkoxy with 1 to 4 C atoms, preferably F, Cl, CN, NO₂, OCH₃, or mono- oligo- or polyfluorinated alkyl or alkoxy with 1 to 4 C atoms
Y⁰¹ and Y⁰² each, independently of one another, denote H, F, Cl or CN,
R⁰¹ and R⁰² have each and independently the meaning as defined above R⁰, and
k and l are each and independently 0, 1, 2, 3 or 4, preferably 0, 1 or 2, most preferably 1.

Preferred polymerisable mono-, di-, or multireactive liquid crystalline compounds are disclosed for example in WO 93/22397, EP 0 261 712, DE 195 04 224, WO 95/22586, WO 97/00600, U.S. Pat. Nos. 5,518,652, 5,750,051, 5,770,107 and 6,514,578.

Preferred polymerisable groups are selected from the group consisting of CH₂═CW¹—COO—, —CH₂═CW¹—CO—,

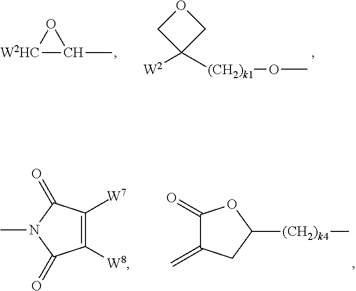

CH₂═CW²—(O)ₖ₃—, CW¹═CH—CO—(O)ₖ₃—, CW¹═CH—CO—NH—, CH₂═CW¹—CO—NH—, —CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, HO—CW²W³—, HS—CW²W³—, HW²N—, HO—CW²W³—NH—, CH₂═CW¹—CO—NH—, —CH₂═CH—(COO)ₖl-Phe-(O)ₖ₂—, CH₂═CH—(CO)ₖ₁-Phe-(O)ₖ₂—, Phe-CH═CH—, HOOC—, OCN— and W⁴W⁵W⁶Si—, in which W¹ denotes H, F, Cl, CN, CF₃, phenyl or alkyl having 1 to 5 C atoms, in particular H, F, Cl or CH₃, W² and W³ each, independently of one another, denote H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W⁸ each, independently of one another, denote H, Cl or alkyl having 1 to 5 C atoms, Phe denotes 1,4-phenylene, which is optionally substituted by one or more radicals L as being defined above but being different from P-Sp, and k₁, k₂ and k₃ each, independently of one another, denote 0 or 1, k₃ preferably denotes 1, and k₄ is an integer from 1 to 10.

Particularly preferred groups P are CH₂═CH—COO—, CH₂═C(CH₃)—COO—, CH₂═CF—COO—, CH₂═CH—, CH₂═CH—O—, (CH₂═CH)₂CH—OCO—, (CH₂═CH)₂CH—O—,

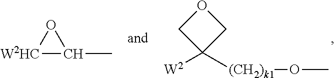

in particular vinyloxy, acrylate, methacrylate, fluoroacrylate, chloroacrylate, oxetane and epoxide.

In a further preferred embodiment of the invention, the polymerisable compounds of the formulae I* and II* and sub-formulae thereof contain, instead of one or more radicals P-Sp-, one or more branched radicals containing two or more polymerisable groups P (multifunctional polymerisable radicals). Suitable radicals of this type, and polymerisable compounds containing them, are described, for example, in U.S. Pat. No. 7,060,200 B1 or US 2006/0172090 A1. Particular preference is given to multifunctional polymerisable radicals selected from the following formulae:

—X-alkyl-CHP¹—CH₂—CH₂P² I*a

—X-alkyl-C(CH₂P¹)(CH₂P²)—CH₂P³ I*b

—X-alkyl-CHP¹CHP²—CH₂P³ I*c

—X-alkyl-C(CH₂P¹)(CH₂P²)—CₐₐH₂ₐₐ₊₁ I*d

—X-alkyl-CHP¹—CH₂P² I*e

—X-alkyl-CHP¹P² I*f

—X-alkyl-CP¹P²—CₐₐH₂ₐₐ₊₁ I*g

—X-alkyl-C(CH₂P¹)(CH₂P²)—CH₂OCH₂—C(CH₂P³)(CH₂P⁴)CH₂P⁵ I*h

—X-alkyl-CH((CH₂)ₐₐP¹)((CH₂)_{bb}P²) I*i

—X-alkyl-CHP¹CHP²—CₐₐH₂ₐₐ₊₁ l*k

in which
alkyl denotes a single bond or straight-chain or branched alkylene having 1 to 12 C atoms, in which one or more non-adjacent CH₂ groups may each be replaced, independently of one another, by —C(R^{x})═C(R^{x})—, —C≡C—, —N(R^{x})—, —O—, —S—, —CO—, —CO—O—, —O—CO—, —O—CO—O— in such a way that O and/or S atoms are not linked directly to one another, and in which, in addition, one or more H atoms may be replaced by F, Cl or CN, where R^{x} has the above-mentioned meaning and preferably denotes R⁰ as defined above,
aa and bb each, independently of one another, denote 0, 1, 2, 3, 4, 5 or 6,
X has one of the meanings indicated for X′, and
P¹⁻⁵ each, independently of one another, have one of the meanings indicated above for P.

Preferred spacer groups Sp are selected from the formula Sp′—X′, so that the radical “P-Sp-” conforms to the formula “P-Sp′—X′—”, where
Sp′ denotes alkylene having 1 to 20, preferably 1 to 12 C atoms, which is optionally mono- or polysubstituted by F, Cl, Br, I or CN and in which, in addition, one or more non-adjacent CH₂ groups may each be replaced, independently of one another, by —O—, —S—, —NH—, —NR^{x}—, —SiR^{x}R^{xx}—, —CO—, —CO—, —OCO—, —OCO—O—, —S—CO—, —CO—S—, —NR^{x}—CO—O—, —O—CO—NR^{x}—, —NR^{x}—CO—NR^{x}—, —CH═CH— or —C≡C— in such a way that 0 and/or S atoms are not linked directly to one another,
X′ denotes —O—, —S—, —CO—, —COO—, —OCO—, —O—COO—, —CO—NR^{x}—, —NR^{x}—CO—, —NR^{x}—CO—NR^{x}—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR^{x}—, —CY²═CY³, —C≡C—, —CH═CH—COO—, —OCO—CH═CH— or a single bond, preferably —O—, —S, —CO—, —COO—, —OCO—, —O—COO—, —CO—NR^{x}—, —NR^{x}—CO—, —NR^{x}—CO—NR^{x}— or a single bond.
R^{x} and R^{xx} each, independently of one another, denote H or alkyl having 1 to 12 C atoms, and
Y² and Y³ each, independently of one another, denote H, F, Cl or CN.

Typical spacer groups Sp′ are, for example, —(CH₂)ₚ₁—, —(CH₂CH₂O)_{q1}—CH₂CH₂—, —CH₂CH₂—S—CH₂CH₂—, —CH₂CH₂—NH—CH₂CH₂— or —(SiR^{x}R^{xx}—O)ₚ₁, —, in which p1 is an integer from 1 to 12, q1 is an integer from 1 to 3, and R^{x} and R^{xx} have the above-mentioned meanings.

Particularly preferred groups —X′-Sp′- are —(CH₂)ₚ₁—, —O—(CH₂)ₚ₁—, —OCO—(CH₂)ₚ₁—, —OCOO—(CH₂)ₚ₁—.

Particularly preferred groups Sp′ are, for example, in each case straight-chain ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethyl-ene-N-methyliminoethylene, 1-methylalkylene, ethenylene, propenylene and butenylene.

Further preferred polymerisable mono-, di-, or multireactive liquid crystalline compounds are shown in the following list:

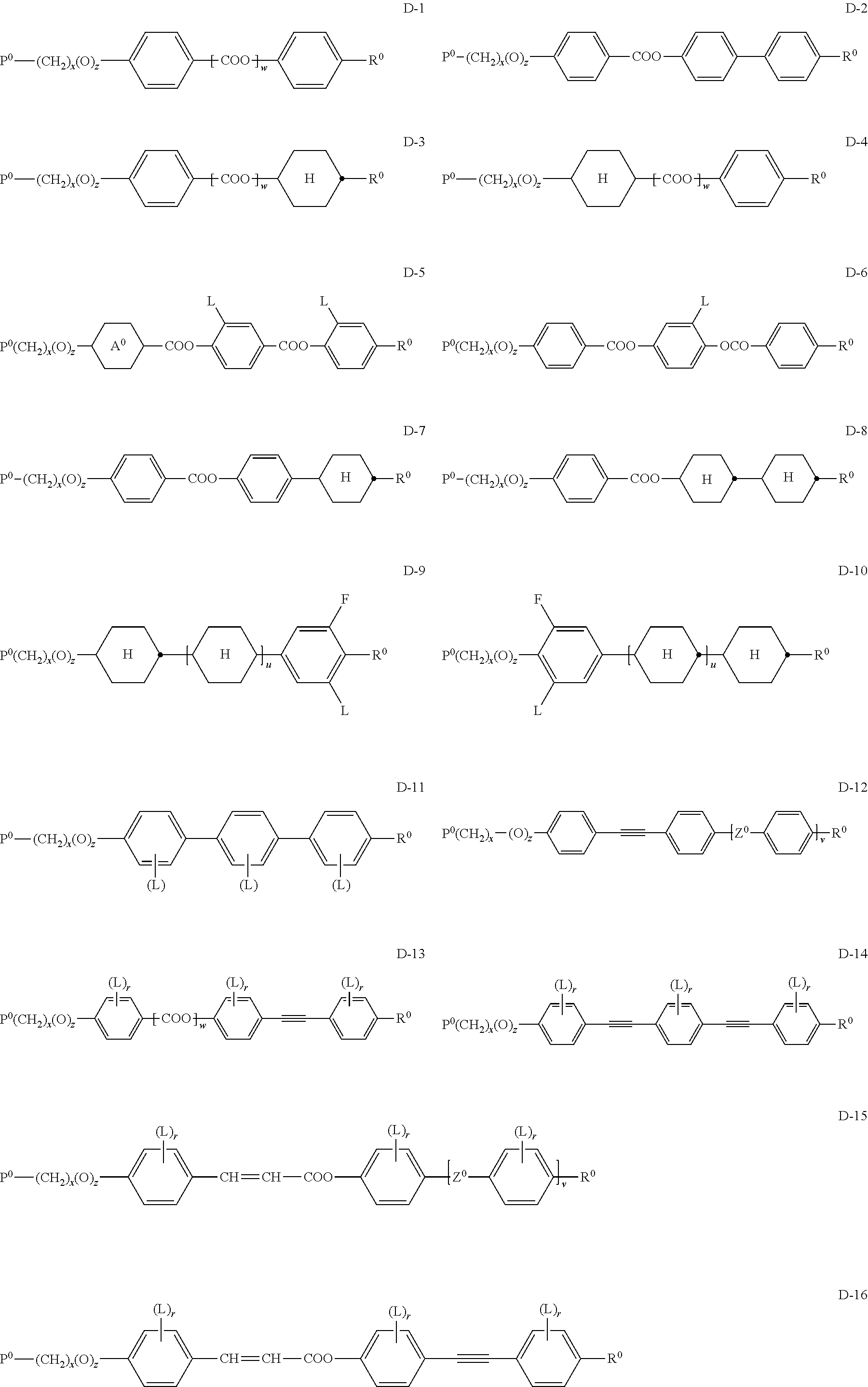

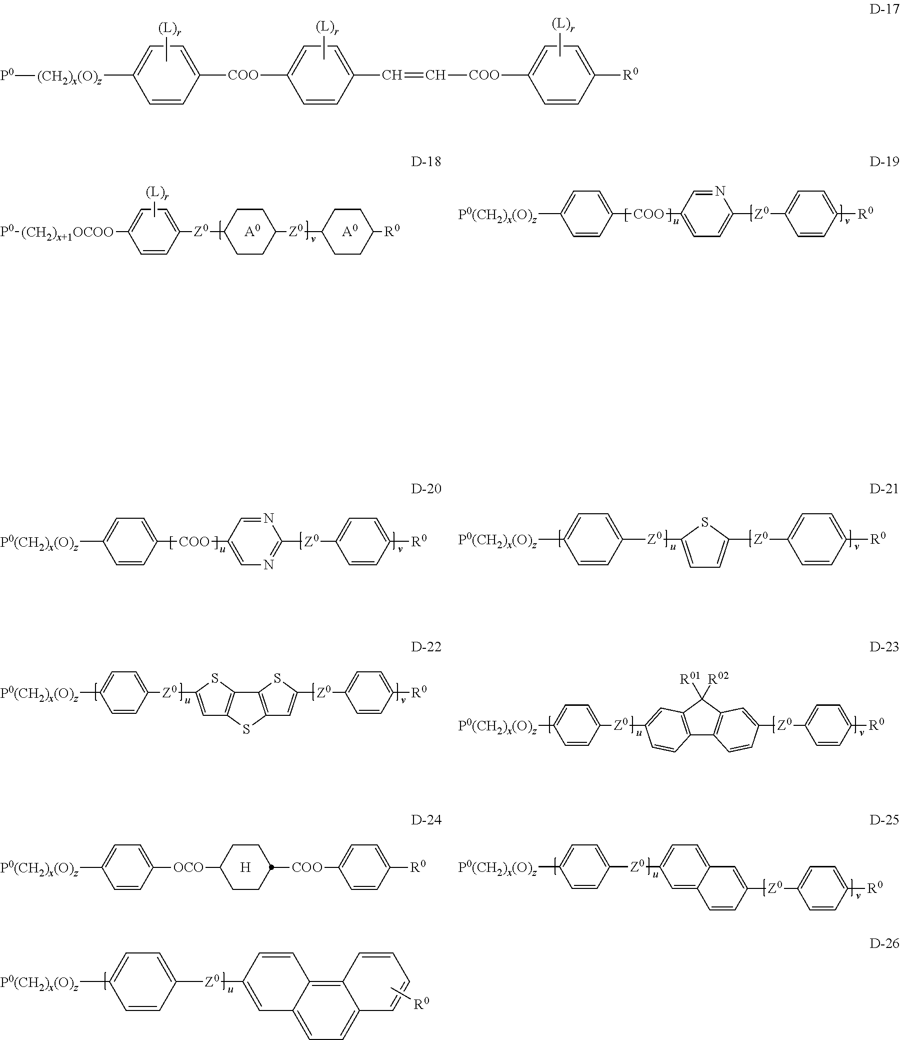

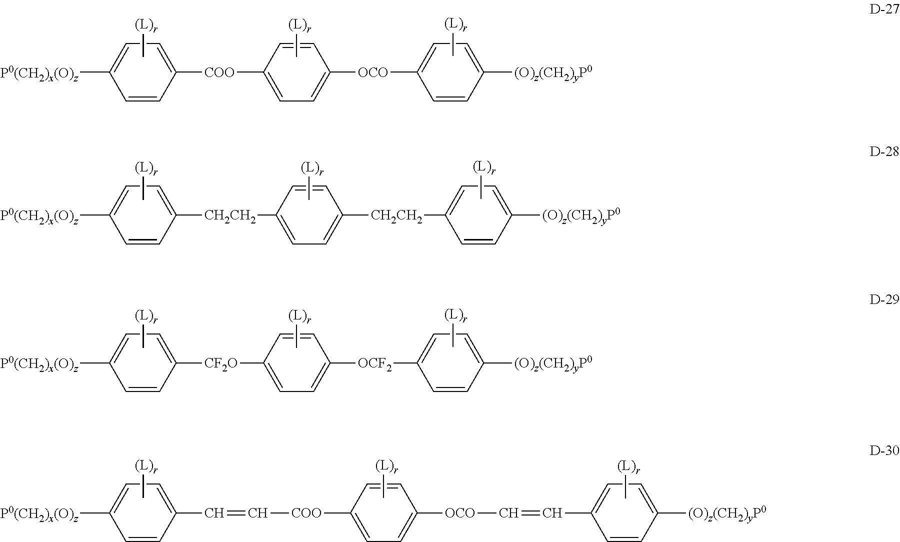

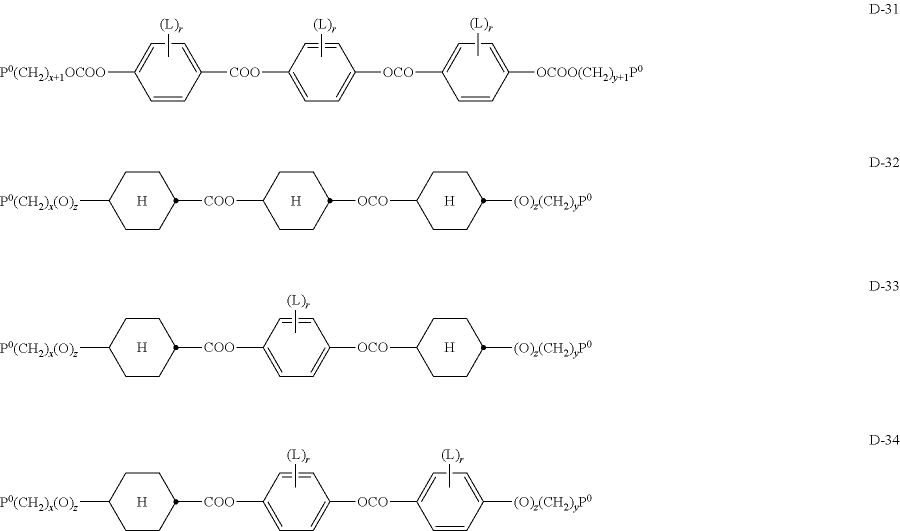

wherein
P⁰ is, in case of multiple occurrences independently of one another, a polymerisable group, preferably an acryl, methacryl, oxetane, epoxy, vinyl, vinyloxy, propenyl ether or styrene group, A⁰ is, in case of multiple occurrence independently of one another, 1,4-phenylene that is optionally substituted with 1, 2, 3 or 4 groups L, or trans-1,4-cyclohexylene,
Z⁰ is, in case of multiple occurrence independently of one another, —COO—, —OCO—, —CH₂CH₂—, —C≡C—, —CH═CH—, —CH═CH—COO—, —OCO—CH═CH— or a single bond,
r is 0, 1, 2, 3 or 4, preferably 0, 1 or 2,
t is, in case of multiple occurrence independently of one another, 0, 1, 2 or 3,
u and v are independently of each other 0, 1 or 2,
w is 0 or 1,
x and y are independently of each other 0 or identical or different integers from 1 to 12,
z is 0 or 1, with z being 0 if the adjacent x or y is 0,

in addition, wherein the benzene and naphthalene rings can additionally be substituted with one or more identical or different groups L and the parameter R⁰, Y⁰, R⁰¹, R⁰² and L have the same meanings as given above in formula D.

The polymerisable compounds are polymerised or cross-linked (if a compound contains two or more polymerisable groups) by in-situ polymerisation in the LC medium between the substrates of the LC display. Suitable and preferred polymerisation methods are, for example, thermal or photopolymerisation, preferably photopolymerisation, in particular UV photopolymerisation. If necessary, one or more initiators may also be added here. Suitable conditions for the polymerisation, and suitable types and amounts of initiators, are known to the person skilled in the art and are described in the literature. Suitable for free-radical polymerisation are, for example, the commercially available photoinitiators Irgacure651®, Irgacurel84®, Irgacure907®, Irgacure369® or Darocurel 173® (Ciba AG). If an initiator is employed, its proportion in the mixture as a whole is preferably 0.001 to 5% by weight, particularly preferably 0.001 to 1% by weight. However, the polymerisation can also take place without addition of an initiator. In a further preferred embodiment, the LC medium does not comprise a polymerisation initiator.

The polymerisable component or the cholesteric liquid-crystalline medium may also comprise one or more stabilisers in order to prevent undesired spontaneous polymerisation of the RMs, for example during storage or transport. Suitable types and amounts of stabilisers are known to the person skilled in the art and are described in the literature. Particularly suitable are, for example, the commercially available stabilisers of the Irganox® series (Ciba AG). If stabilisers are employed, their proportion, based on the total amount of RMs or polymerisable compounds, is preferably 10-5000 ppm, particularly preferably 50-500 ppm.

The above-mentioned polymerisable compounds are also suitable for polymerisation without initiator, which is associated with considerable advantages, such as, for example, lower material costs and in particular less contamination of the LC medium by possible residual amounts of the initiator or degradation products thereof.

The polymerisable compounds can be added individually to the cholesteric liquid-crystalline medium, but it is also possible to use mixtures comprising two or more polymerisable compounds. On polymerisation of mixtures of this type, copolymers are formed. The invention furthermore relates to the polymerisable mixtures mentioned above and below.

The cholesteric liquid-crystalline medium which can be used in accordance with the invention is prepared in a manner conventional per se, for example by mixing one or more of the above-mentioned compounds with one or more polymerisable compounds as defined above and optionally with further liquid-crystalline compounds and/or additives. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

It goes without saying to the person skilled in the art that the LC media may also comprise compounds in which, for example, H, N, O, Cl, F have been replaced by the corresponding isotopes.

The liquid crystal media may contain further additives like for example further stabilizers, inhibitors, chain-transfer agents, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes, pigments or nanoparticles in usual concentrations.

The total concentration of these further constituents is in the range of 0.1% to 10%, preferably 0.1% to 6%, based on the total mixture. The concentrations of the individual compounds used each are preferably in the range of 0.1% to 3%. The concentration of these and of similar additives is not taken into consideration for the values and ranges of the concentrations of the liquid crystal components and compounds of the liquid crystal media in this application. This also holds for the concentration of the dichroic dyes used in the mixtures, which are not counted when the concentrations of the compounds respectively the components of the host medium are specified. The concentration of the respective additives is always given relative to the final doped mixture.

In general, the total concentration of all compounds in the media according to this application is 100%.

A typical method for the production of a light modulation element according to the invention comprises at least the following steps:
cutting and cleaning of the substrates,
providing the electrode structure on the substrates,
coating of at least one alignment layer on the electrode structure of at least one substrate,
processing of one alignment layer on the electrode structure of one substrate,
assembling the cell using a UV curable adhesive,
filling the cell with the cholesteric liquid-crystalline medium,
optionally, obtaining the ULH texture, by applying an electric field to the LC medium whilst cooling slowly from the isotropic phase into the cholesteric phase, and
optionally, curing the polymerisable compounds of the LC medium.

The functional principle of the device according to the invention will be explained in detail below. It is noted that no restriction of the scope of the claimed invention, which is not present in the claims, is to be derived from the comments on the assumed way of functioning.

Preferably and in the case of a perfect alignment system, the ULH texture is spontaneously formed, and as such no field would be required in this case.

Preferably, in the case of spontaneous ULH alignment, the control of temperature is also not be necessary, but still within the useable nematic range of the mixture. And also within the range in which the device can be filled.

In a further preferred embodiment, it is possible to obtain the ULH texture, starting from the focal conic or Grandjean texture, by applying an electric field with a high frequency, of for example 10 V and 200 Hz, to the cholesteric liquid-crystalline medium whilst cooling slowly from its isotropic phase into its cholesteric phase. The field frequency may differ for different media.

Starting from the ULH texture, the cholesteric liquid-crystalline medium can be subjected to flexoelectric switching by application of an electric field. This causes rotation of the optic axis of the material in the plane of the cell substrates, which leads to a change in transmission when placing the material between crossed polarizers. The flexoelectric switching of inventive materials is further described in detail in the introduction above and in the examples. The uniform lying helix texture in the “off state” of the light modulation element in accordance with the present invention provides significant improved optical extinction and therefore a favourable contrast. In addition the ULH texture is stable after removing the voltage and remains for several days/weeks.

The optics of the device are to some degree self-compensating (similar to a conventional pi-cell) and provide better viewing angle than a conventional light modulation element according to the VA mode.

The required applied electric field strength is mainly dependent on the electrode gap and the e/K of the host mixture. The applied electric field strengths are typically lower than approximately 10 V/μm⁻¹, preferably lower than approximately 8 V/μm¹ and more preferably lower than approximately 5 V/μm⁻¹. Correspondingly, the applied driving voltage of the light modulation element according to the present invention is preferably lower than approximately 30 V, more preferably lower than approximately 20 V, and even more preferably lower than approximately 10 V.

The light modulation element according to the present invention can be operated with a conventional driving waveform as commonly known by the expert.

The light modulation element of the present invention can be used in various types of optical and electro-optical devices.

Said optical and electro optical devices include, without limitation electro-optical displays, liquid crystal displays (LCDs), non-linear optic (NLO) devices, and optical information storage devices.

Unless the context clearly indicates otherwise, as used herein plural forms of the terms herein are to be construed as including the singular form and vice versa.

The parameter ranges indicated in this application all include the limit values including the maximum permissible errors as known by the expert. The different upper and lower limit values indicated for various ranges of properties in combination with one another give rise to additional preferred ranges.

Throughout this application, the following conditions and definitions apply, unless expressly stated otherwise. All concentrations are quoted in percent by weight and relate to the respective mixture as a whole, all temperatures are quoted in degrees Celsius and all temperature differences are quoted in differential degrees. All physical properties are determined in accordance with “Merck Liquid Crystals, Physical Properties of Liquid Crystals”, Status November 1997, Merck KGaA, Germany, and are quoted for a temperature of 20° C., unless expressly stated otherwise. The optical anisotropy (Δn) is determined at a wavelength of 589.3 nm. The dielectric anisotropy (Δε) is determined at a frequency of 1 kHz or if explicitly stated at a frequency 19 GHz. The threshold voltages, as well as all other electro-optical properties, are determined using test cells produced at Merck KGaA, Germany. The test cells for the determination of Δε have a cell thickness of approximately 20 μm. The electrode is a circular ITO electrode having an area of 1.13 cm² and a guard ring. The orientation layers are SE-1211 from Nissan Chemicals, Japan, for homeotropic orientation (ε∥) and polyimide AL-1054 from Japan Synthetic Rubber, Japan, for homogeneous orientation (ε_{⊥}). The capacitances are determined using a Solatron 1260 frequency response analyser using a sine wave with a voltage of 0.3 Vᵣₘₛ. The light used in the electro-optical measurements is white light. A set-up using a commercially available DMS instrument from Autronic-Melchers, Germany, is used here.

Throughout the description and claims of this specification, the words “comprise” and “contain” and variations of the words, for example “comprising” and “comprises”, mean “including but not limited to”, and are not intended to (and do not) exclude other components. On the other hand, the word “comprise” also encompasses the term “consisting of” but is not limited to it.

It will be appreciated that many of the features described above, particularly of the preferred embodiments, are inventive in their own right and not just as part of an embodiment of the present invention.

Independent protection may be sought for these features in addition to, or alternative to any invention presently claimed.

Throughout the present application it is to be understood that the angles of the bonds at a C atom being bound to three adjacent atoms, e.g. in a C═C or C═O double bond or e.g. in a benzene ring, are 120° and that the angles of the bonds at a C atom being bound to two adjacent atoms, e.g. in a C≡C or in a C≡N triple bond or in an allylic position C═C═C are 180°, unless these angles are otherwise restricted, e.g. like being part of small rings, like 3-, 5- or 5-atomic rings, notwithstanding that in some instances in some structural formulae these angles are not represented exactly.

It will be appreciated that variations to the foregoing embodiments of the invention can be made while still falling within the scope of the invention. Alternative features serving the same, equivalent or similar purpose may replace each feature disclosed in this specification, unless stated otherwise. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

Without further elaboration, it is believed that one skilled in the art can, using the preceding description, utilize the present invention to its fullest extent. The following examples are, therefore, to be construed as merely illustrative and not limitative of the remainder of the disclosure in any way whatsoever.

The following abbreviations are used to illustrate the liquid crystalline phase behavior of the compounds: K=crystalline; N=nematic; N2=Twist-Bend nematic; S=smectic; Ch=cholesteric; I=isotropic; Tg=glass transition. The numbers between the symbols indicate the phase transition temperatures in ° C.

In the present application and especially in the following examples, the structures of the liquid crystal compounds are represented by abbreviations, which are also called “acronyms”. The transformation of the abbreviations into the corresponding structures is straightforward according to the following three tables A to C.

All groups CₙH₂ₙ₊₁, CₘH₂ₘ₊₁, and CₗH₂ₗ₊₁ are preferably straight chain alkyl groups with n, m and l C-atoms, respectively, all groups CₙH₂ₙ, CₘH₂ₘ and CₗH₂ₗ are preferably (CH₂)ₙ, (CH₂)ₘ and (CH₂)ₗ, respectively and —CH═CH— preferably is trans-respectively Evinylene.

Table A lists the symbols used for the ring elements, table B those for the linking groups and table C those for the symbols for the left hand and the right hand end groups of the molecules.

TABLE A
Ring Elements

| | |
|---|---|
| C | 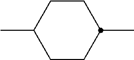 |
| P | 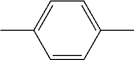 |
| D | 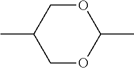 |
| DI | 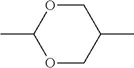 |
| A | 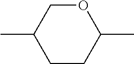 |
| AI | 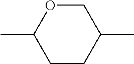 |
| G | 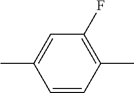 |
| GI | 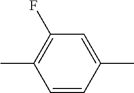 |
| G(Cl) | 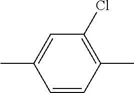 |
| GI(Cl) | 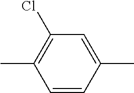 |
| G(1) | 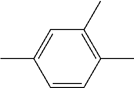 |
| GI(1) | 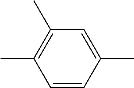 |
| U | 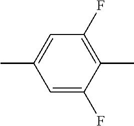 |
| UI | 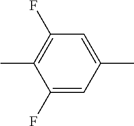 |
| Y | 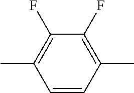 |
| M | 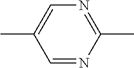 |
| MI | 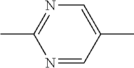 |
| N | 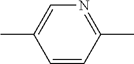 |
| NI | 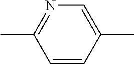 |
| np | 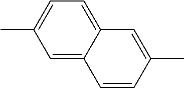 |
| n3f | 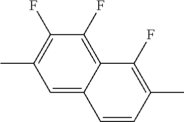 |
| n3fI | 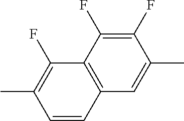 |
| th | 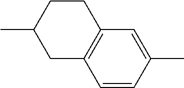 |
| thI | 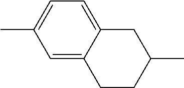 |
| th2f | 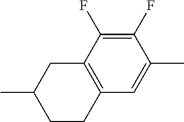 |
| th2fI | 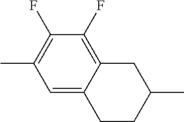 |
| o2f | 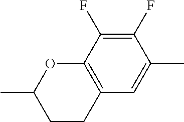 |
| o2fI | 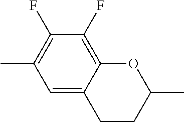 |
| dh | 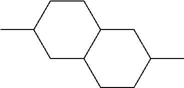 |
| K | 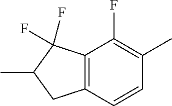 |
| KI | 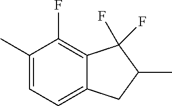 |
| L | 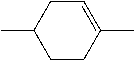 |
| LI | 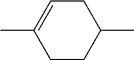 |
| F | 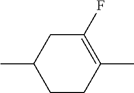 |
| FI | 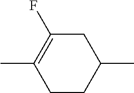 |

TABLE B
Linking Groups

| | | |
|---|---|---|
| n | (—CH₂—)ₙ | “n” is an integer except 0 and 2 |

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End Groups

| Left hand side, used alone or in | | Right hand side, used alone or | |
|---|---|---|---|
| combination with others | | in combination with others | |
| -n- | CₙH₂ₙ₊₁— | -n | —CₙH₂ₙ₊₁ |
| -nO- | CₙH₂ₙ₊₁—O— | -nO | —O—CₙH₂ₙ₊₁ |
| -V- | CH₂═CH— | -V | —CH═CH₂ |
| -nV- | CₙH₂ₙ₊₁—CH═CH— | -nV | —CₙH₂ₙ—CH═CH₂ |
| -Vn- | CH₂═CH— CₙH₂ₙ— | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| -N- | N≡C— | -N | —C≡N |
| -S- | S═C═N— | -S | —N═C═S |
| -F- | F— | -F | —F |
| -CL- | Cl— | -CL | —Cl |
| -M- | CFH₂— | -M | —CFH₂ |
| -D- | CF₂H— | -D | —CF₂H |
| -T- | CF₃— | -T | —CF₃ |
| -MO- | CFH₂O— | -OM | —OCFH₂ |
| -DO- | CF₂HO— | -OD | —OCF₂H |
| -TO- | CF₃O— | -OT | —OCF₃ |
| -A- | H—C≡C— | -A | —C≡C—H |
| -nA- | CₙH₂ₙ₊₁—C≡C— | -An | —C≡C—CₙH₂ₙ₊₁ |
| -NA- | N≡C—C≡C— | -AN | —C≡C—C≡N |
| Left hand side, used in | | Right hand side, used in | |
| combination with others only | | combination with others only | |
| - . . . n . . . - | —CₙH₂ₙ— | - . . . n . . . | —CₙH₂ₙ— |
| - . . . M . . . - | —CFH— | - . . . M . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |

wherein n und m each are integers and three points “ . . . ” indicate a space for other symbols of this table.

### EXAMPLES

The invention will now be described in more detail by reference to the following working examples, which are illustrative only, and do not limit the scope of the invention.

### Mixture Examples

The following LC-mixture (M-1) is prepared:

| | Amount |
|---|---|
| Compound | [%-w/w] |
| R-5011 | 2.00 |
| F-PGI-ZI-5-Z-PU-F | 8.84 |
| F-PGI-ZI-7-Z-PU-F | 8.58 |
| F-PGI-ZI-9-Z-PU-F | 8.58 |
| N-PP-ZI-7-Z-GP-F | 9.00 |
| N-PP-ZI-9-Z-GP-F | 7.20 |
| N-PUIUI-ZI-9-Z-GP-F | 14.40 |
| F-PGI-9-GP-F | 4.25 |
| F-GIGI-9-GPG-F | 4.25 |
| N-PGI-ZI-9-Z-GU-F | 5.40 |
| F-PGI-7-GP-F | 4.25 |
| F-UIP-9-PU-F | 4.25 |
| CLY-3-O2 | 1.52 |
| Y-4O-O4 | 2.66 |
| CPY-2-O2 | 1.90 |
| CCY-4-O2 | 1.52 |
| CCY-3-O2 | 1.90 |
| CPY-3-O2 | 1.90 |
| PY-3-O2 | 1.90 |
| CY-3-O2 | 2.66 |
| CCY-3-O1 | 1.52 |
| CCY-3O-3 | 1.52 |

### Example 1: Test Cells with Polyimide AL-3046

### Comparative Example 1.1

A comparative test cell consisting of the following layer stack:
1^{st} substrate
1^{st} electrode structure,
unprocessed alignment layer,
cholesteric liquid crystalline medium,
unprocessed alignment layer,
2^{nd} electrode structure, and
2^{nd} substrate

is produced by the following process.

Pre-patterned ITO glass substrates are cleaned and two substrates were spin coated with the planar polyimide AL-3046 (Japan Synthetic Rubber, JSR, Japan). Both polyimide coated substrates are pre-cured on a hotplate for 1 min at 100° C. and final curing is done at 200° C. for 90 min in an oven.

A temperature curable frame sealant is applied and 3 μm spacer are sprayed onto one substrate. Both substrates are assembled in a way that the rubbing directions of the processed polyimide layers are arranged in the anti-parallel direction, pressed to the desired cell gap of 3 m and the adhesive is cured at 150° C. Single test cells are cut out for the alignment experiments and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage the black state is rated by microscopic observation.

The cells show no ULH texture.

### Comparative Example 1.2

A comparative test cell consisting of the following layer stack:
1^{st} substrate
1^{st} electrode structure,
processed alignment layer,
cholesteric liquid crystalline medium,
processed alignment layer,
2^{nd} electrode structure, and
2^{nd} substrate

is produced by the following process.

Pre-patterned ITO glass substrates are cleaned and two substrates were spin coated with the planar polyimide AL-3046 (Japan Synthetic Rubber, JSR, Japan). Both polyimide coated substrates are pre-cured on a hotplate for 1 min at 100° C. and final curing is done at 200° C. for 90 min in an oven. Both polyimide-coated substrates are treated by rubbing with a rotating roller covered with a rayon cloth to induce a preferred LC orientation.

A temperature curable frame sealant is applied and 3 μm spacer are sprayed onto one substrate. Both substrates are assembled in a way that the rubbing directions of the processed polyimide layers are arranged in the anti-parallel direction, pressed to the desired cell gap of 3 m and the adhesive is cured at 150° C. Single test cells are cut out for the alignment experiments and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage the black state is rated by microscopic observation.

The cells show some defects in the ULH texture and re-orientation to USH starts in a few hours.

### Example 1.3

A test cell in accordance with the present invention consisting of the following layer stack:
1^{st} substrate
1^{st} electrode structure,
processed alignment layer,
cholesteric liquid crystalline medium,
2^{nd} electrode structure, and
2^{nd} substrate

is produced by the following process.

Pre-patterned ITO glass substrates are cleaned and one substrate is spin coated with the planar polyimide AL-3046 (Japan Synthetic Rubber, JSR, Japan). The polyimide layer is pre-cured on a hotplate for 1 min at 100° C. and final curing is done at 200° C. for 90 min in an oven. The polyimide coated substrate is treated by rubbing with a rotating roller covered with a rayon cloth to induce a preferred LC orientation.

A temperature curable frame sealant is applied and 3 μm spacer are sprayed onto the substrate. On top of the substrate with the processed polyimide layer a blank pre-patterned ITO substrate is placed, pressed to the desired cell gap of 3 μm and the adhesive is cured at 150° C. Single test cells are cut out for the alignment experiments, and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The cells show less defect areas in the ULH texture compared to the comparative example 1.2 and the stability of the ULH texture is significant improved without re-orientation to USH for at least several weeks (in comparative example 1.2 USH domains appears after a few hours).

### Example 1.4

A test cell in accordance with the present invention consisting of the following layer stack:
1^{st} substrate
1^{st} electrode structure,
processed alignment layer,
cholesteric liquid crystalline medium,
unprocessed alignment layer,
2^{nd} electrode structure, and
2^{nd} substrate

is produced by the following process.

Pre-patterned ITO glass substrates are cleaned and two substrates were spin coated with the planar polyimide AL-3046 (Japan Synthetic Rubber, JSR, Japan). The polyimide layer is pre-cured on a hotplate for 1 min at 100° C. and final curing is done at 200° C. for 90 min in an oven. One polyimide coated substrate is treated by rubbing with a rotating roller covered with a rayon cloth to induce a preferred LC orientation; the 2^{nd} substrate is not processed.

A temperature curable frame sealant is applied and 3 μm spacer are sprayed onto one substrate. Both substrates are assembled, pressed to the desired cell gap of 3 μm and the adhesive is cured at 150° C. Single test cells are cut out for the alignment experiments and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The cells show less defect areas in the ULH texture compared to the comparative Example 1.2 and the stability of the ULH texture is significant improved without re-orientation to USH for at least several weeks (in the comparative example 1.2 USH domains appears after a few hours).

### Summary Example 1

The results of example 1 are summarized in the following table:

| | | | Defects in | Stability of |
|---|---|---|---|---|
| | 1^{st} alignment | 2^{nd} alignment | the ULH | the ULH |
| No. | layer | layer | texture | texture |
| Comparative | AL-3046 | AL-3046 | n.a. | n.a. |
| example 1.1 | (unprocessed) | (unprocessed) | | |
| Comparative | AL-3046 | AL-3046 | ∘ | −− |
| example 1.2 | (processed) | (processed) | | |
| Example 1.3 | AL-3046 | | ++ | ++ |
| | (processed) | | | |
| Example 1.4 | AL-3046 | AL-3046 | ++ | ++ |
| | (processed) | (unprocessed) | | |

++ very favorable
+ favorable
∘ average
− poor
−− very Door
n.a not applicable

### Example 2: Test Cells with Polyimide AL-1254

### Comparative Example 2.1

A comparative test cell consisting of the following layer stack:
1^{st} substrate
1^{st} electrode structure,
unprocessed alignment layer,
cholesteric liquid crystalline medium,
unprocessed alignment layer,
2^{nd} electrode structure, and
2^{nd} substrate

is produced by the following process.

Pre-patterned ITO glass substrates are cleaned and two substrates were spin coated with the planar polyimide AL-1254 (Japan Synthetic Rubber, JSR, Japan). The polyimide layer is pre-cured on a hotplate for 1 min at 100° C. and final curing is done at 180° C. for 90 min in an oven.

A temperature curable frame sealant is applied and 3 μm spacer are sprayed onto one substrate. Both substrates are assembled in a way that the rubbing directions of the processed polyimide layers are arranged in the anti-parallel direction, pressed to the desired cell gap of 3 m and the adhesive is cured at 150° C. Single test cells are cut out for the alignment experiments, and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The test cells show no ULH texture.

### Comparative Example 2.2

A comparative test cell consisting of the following layer stack:
1^{st} substrate
1^{st} electrode structure,
processed alignment layer,
cholesteric liquid crystalline medium,
processed alignment layer,
2^{nd} electrode structure, and
2^{nd} substrate

is produced by the following process.

Pre-patterned ITO glass substrates are cleaned and two substrates were spin coated with the planar polyimide AL-1254 (Japan Synthetic Rubber, JSR, Japan). The polyimide layer is pre-cured on a hotplate for 1 min at 100° C. and final curing is done at 180° C. for 90 min in an oven. Both polyimide coated substrates are treated by rubbing with a rotating roller covered with a rayon cloth to induce a preferred LC orientation. A temperature curable frame sealant is applied and 3 μm spacer are sprayed onto one substrate. Both substrates are assembled in a way that the rubbing directions of the processed polyimide layers are arranged in the anti-parallel direction, pressed to the desired cell gap of 3 m and the adhesive is cured at 150° C. Single test cells are cut out for the alignment experiments, and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The test cells show some defects in the ULH texture and re-orientation to the USH texture starts within a few hours.

### Example 2.3

A light modulation element in accordance with the present invention consisting of the following layer stack:
1^{st} substrate
1^{st} electrode structure,
processed alignment layer,
cholesteric liquid crystalline medium,
2^{nd} electrode structure, and
2^{nd} substrate

is produced by the following process.

Pre-patterned ITO glass substrates are cleaned and one substrate is spin coated with the planar polyimide AL-1254 (Japan Synthetic Rubber, JSR, Japan). The polyimide layer is pre-cured on a hotplate for 1 min at 100° C. and final curing is done at 180° C. for 90 min in an oven. The polyimide coated substrate is treated by rubbing with a rotating roller covered with a rayon cloth to induce a preferred LC orientation.

A temperature curable frame sealant is applied and 3 μm spacer are sprayed onto the substrate. On top of the substrate with the processed polyimide layer a blank pre-patterned ITO substrate is placed, pressed to the desired cell gap of 3 μm and the adhesive is cured at 150° C. Single test cells are cut out for the alignment experiments, and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The cells show less defect areas in the ULH texture compared to the comparative example 2.2 and the stability of the ULH texture is significantly improved without re-orientation to the USH texture for at least several weeks (in the comparative example 2.2 USH domains appears after a few hours).

### Example 2.4

A test cell in accordance with the present invention consisting of the following layer stack:
1^{st} substrate
1^{st} electrode structure,
processed alignment layer,
cholesteric liquid crystalline medium,
unprocessed alignment layer,
2^{nd} electrode structure, and
2^{nd} substrate

is produced by the following process.

Pre-patterned ITO glass substrates are cleaned and two substrates were spin coated with the planar polyimide AL-1254 (Japan Synthetic Rubber, JSR, Japan). The polyimide layer is pre-cured on a hotplate for 1 min at 100° C. and final curing is done at 180° C. for 90 min in an oven. One polyimide coated substrate is treated by rubbing with a rotating roller covered with a rayon cloth to induce a preferred LC orientation, the 2^{nd} substrate is not processed.

A temperature curable frame sealant is applied and 3 μm spacer are sprayed onto one substrate. Both substrates are assembled, pressed to the desired cell gap of 3 μm and the adhesive is cured at 150° C. Single test cells are cut out for the alignment experiments, and filled with mixture M1 at 80° C. by capillary filling.

The filled test cells are heated up above the clearing point to 75° C. and a square wave voltage of 20 Volt with 200 Hz is applied. The cells are cooled down with voltage and after turning off the driving voltage, the black state is rated by microscopic observation.

The cells show less defect areas compared to the comparative example 2.2 and the stability of the ULH texture is significantly improved without re-orientation to the USH texture for at least several weeks (in the comparative example 2.2 USH domains appears after a few hours). The cell with one side processed polyimide and opposite side unprocessed polyimide show surprisingly very good ULH alignment with significant better stability compared to the two sides polyimide coated and processed version (comparative example 2.2).

The ULH alignment of example 2.3 (only one side processed polyimide) is slightly better compared to this example 2.4 (2 sides polyimide with one side processed),

### Summary Example 2

The results of example 2 are summarized in the following table:

| | | | Defects in | Stability of |
|---|---|---|---|---|
| | 1^{st} alignment | 2^{nd} alignment | the ULH | the ULH |
| No. | layer | layer | texture | texture |
| Comparative | AL-1254 | AL-1254 | n.a. | n.a |
| example 2.1 | (unprocessed) | (unprocessed) | | |
| Comparative | AL-1254 | AL-1254 | ∘ | −− |
| example 2.2 | (processed) | (processed) | | |
| Example 2.3 | AL-1254 | | ++ | ++ |
| | (processed) | | | |
| Example 2.4 | AL-1254 | AL-1254 | + | + |
| | (processed) | (unprocessed) | | |

++ very favorable
+ favorable
∘ average
− poor
−− very poor
n.a. not applicable

1. Light modulation element comprising a cholesteric liquid crystalline medium sandwiched between two opposing substrates, an electrode arrangement, which is capable to allow the application of an electric field, which is substantially perpendicular to the main plane of substrate or the layer of the cholesteric liquid-crystalline medium, characterized in that one of the substrates is provided with a processed alignment layer adjacent to the cholesteric liquid crystalline medium and the other substrate is either provided with an unprocessed alignment layer adjacent to the cholesteric liquid crystalline medium or is not provided with an alignment layer.

2. Light modulation element according to claim 1, characterized in that one of the substrates is provided with a processed alignment layer adjacent to the cholesteric liquid crystalline medium and the other substrate is provided with an unprocessed alignment layer adjacent to the cholesteric liquid crystalline medium.

3. Light modulation element according to claim 1, characterized in that one of the substrates is provided with a processed alignment layer adjacent to the cholesteric liquid crystalline medium and the other substrate is not provided with an alignment layer adjacent to the cholesteric liquid crystalline medium.

4. Light modulation element according to claim 1, characterized in that one of the substrates is provided with a processed alignment layer adjacent to the cholesteric liquid crystalline medium and the other substrate is provided with a dielectric layer adjacent to the cholesteric liquid crystalline medium.

5. Light modulation element according to claim 1, wherein the electrode structure is provided as an electrode layer on the entire substrate and/or the pixel area.

6. Light modulation element according to claim 1, wherein the alignment layer induces a planar alignment to the adjacent liquid crystal molecules.

7. Light modulation element according to claim 1, wherein the processed alignment layer is processed by rubbing.

8. Light modulation element according to claim 1, comprising two or more polarisers, at least one of which is arranged on one side of the layer of the liquid-crystalline medium and at least one of which is arranged on the opposite side of the layer of the liquid-crystalline medium.

9. Light modulation element according to claim 1, wherein the cholesteric liquid-crystalline medium comprises at least one bimesogenic compound and at least one chiral compound.

10. Light modulation element according to claim 1, wherein the cholesteric liquid-crystalline medium comprises at least one bimesogenic compound, at least one chiral compound and one or more nematogenic compounds.

11. Light modulation element according to claim 1, wherein the cholesteric liquid-crystalline medium comprises at least one bimesogenic compound which is selected from the group of compounds of formulae A-I to A-III, 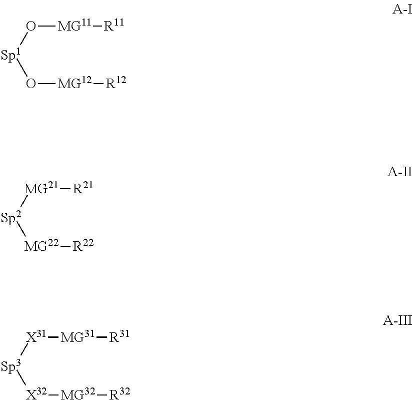
wherein
R¹¹ and R¹², R²¹ and R²², and R³¹ and R³² are each independently H, F, Cl, CN, NCS or a straight-chain or branched alkyl group with 1 to 25 C atoms which may be unsubstituted, mono- or polysubstituted by halogen or CN, it being also possible for one or more non-adjacent CH₂ groups to be replaced, in each occurrence independently from one another, by —O—, —S—, —NH—, —N(CH₃)—, —CO—, —COO—, —OCO—, —O—CO—O—, —S—CO—, —CO—S—, —CH═CH—, —CH═CF—, —CF═CF— or —C≡C— in such a manner that oxygen atoms are not linked directly to one another,
MG¹¹ and MG¹², MG²¹ and MG²² and MG³¹ and MG³² are each independently a mesogenic group,
Sp¹, Sp² and Sp³ are each independently a spacer group comprising 5 to 40 C atoms, wherein one or more non-adjacent CH₂ groups, with the exception of the CH₂ groups of Sp¹ linked to O-MG¹¹ and/or 0-MG¹², of Sp² linked to MG²¹ and/or MG²² and of Sp³ linked to X³¹ and X³², may also be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—, however in such a way that no two O-atoms are adjacent to one another, no two —CH═CH— groups are adjacent to each other, and no two groups selected from —O—CO—, —S—CO—, —O—COO—, —CO—S—, —CO—O— and —CH═CH— are adjacent to each other, and
X³¹ and X³² are independently from one another a linking group selected from —CO—O—, —O—CO—, —CH═CH—, —C≡C— or —S—, and, alternatively, one of them may also be either —O— or a single bond, and,
again alternatively, one of them may be —O— and the other one a single bond.

12. Light modulation element according to claim 1, wherein the cholesteric liquid-crystalline medium comprises one or more chiral compounds, which are selected from the group of compounds of formulae C-I to C-III, 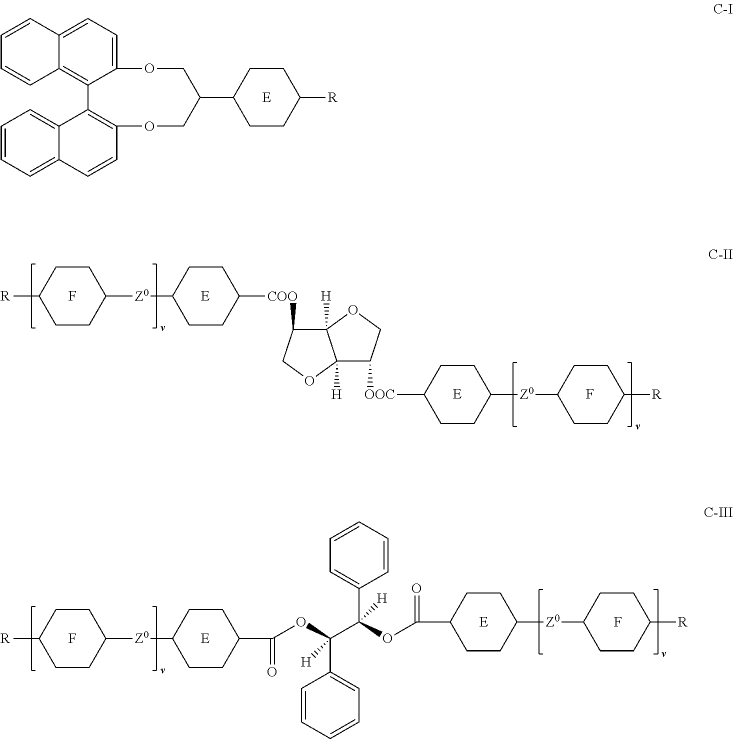
including the respective (S,S) enantiomers, and
wherein
E and F are each independently 1,4-phenylene or trans-1,4-cyclohexylene,
v is 0 or 1,
Z⁰ is —COO—, —OCO—, —CH₂CH₂— or a single bond, and
R is alkyl, alkoxy or alkanoyl with 1 to 12 C atoms.

13. Light modulation element according to claim 1, wherein the cholesteric liquid-crystalline medium comprises one or more polymerisable liquid-crystalline compounds which are selected from the group of compounds of formula D,
P-Sp-MG-R⁰ D
wherein
P is a polymerisable group,
Sp is a spacer group or a single bond,
MG is a rod-shaped mesogenic group, which is preferably selected of formula M,
M is -(A^{D21}-Z^{D21})ₖ-A^{D22}-(Z^{D22}-A^{D23})ₗ-,
A^{D21} to A^{D23} are in each occurrence independently of one another an aryl-, heteroaryl-, heterocyclic- or alicyclic group optionally being substituted by one or more identical or different groups L, preferably 1,4-cyclohexylene or 1,4-phenylene, 1,4 pyridine, 1,4-pyrimidine, 2,5-thiophene, 2,6-dithieno[3,2-b:2′,3′-d]thiophene, 2,7-fluorine, 2,6-naphtalene, 2,7-phenanthrene optionally being substituted by one or more identical or different groups L,
Z^{D21} and Z^{D22} are in each occurrence independently from each other, —O—, —S—, —CO—, —COO—, —OCO—, —S—CO—, —CO—S—, —O—COO—, —CO—NR⁰¹—, —NR⁰¹—CO—, —NR⁰¹—CO—NR⁰², —NR⁰¹—CO—O—, —O—CO—NR⁰¹—, —OCH₂—, —CH₂O—, —SCH₂—, —CH₂S—, —CF₂O—, —OCF₂—, —CF₂S—, —SCF₂—, —CH₂CH₂—, —(CH₂)₄—, —CF₂CH₂—, —CH₂CF₂—, —CF₂CF₂—, —CH═N—, —N═CH—, —N═N—, —CH═CR⁰¹—, —CY⁰¹═CY⁰²—, —C═C—, —CH═CH—COO—, —OCO—CH═CH—, or a single bond,
L is in each occurrence independently of each other F or Cl,
R⁰ is H, alkyl, alkoxy, thioalkyl, alkylcarbonyl, alkoxycarbonyl, alkylcarbonyloxy or alkoxycarbonyloxy with 1 to 20 C atoms more, or is Y⁰ or P-Sp-,
Y⁰ is F, Cl, CN, NO₂, OCH₃, OCN, SCN, optionally fluorinated alkylcarbonyl, alkoxycarbonyl, alkylcarbonyloxy or alkoxycarbonyloxy with 1 to 4 C atoms, or mono- oligo- or polyfluorinated alkyl or alkoxy with 1 to 4 C atoms,
Y⁰¹ and Y⁰² each, independently of one another, denote H, F, Cl or CN,
R⁰¹ and R⁰² have each and independently the meaning as defined above R⁰, and
k and l are each and independently 0, 1, 2, 3 or 4.

14. Method for the production of a light modulation element according to claim 1 comprising at least the following steps:
cutting and cleaning of the substrates,
providing the electrode structure on the substrates, coating of at least one alignment layer on the electrode structure of at least one substrate,
processing of one alignment layer,
assembling the cell using a UV curable adhesive,
filling the cell with the cholesteric liquid-crystalline medium, optionally, obtaining the ULH texture, by applying an electric field to the LC medium whilst cooling slowly from the isotropic phase into the cholesteric phase, and
optionally, curing the polymerisable compounds of the LC medium.

15. Use of the light modulation element according to claim 1 in optical or electro-optical devices.

16. Optical or electro-optical device comprising light modulation element according to claim 1.

17. Optical or electro-optical device according to claim 16, characterized in that it is an electro-optical display, liquid crystal display (LCDs), non-linear optic (NLO) device, or optical information storage device.
